(19) United States
(12) Patent Application Publication
(10) Pub. No.: US 2001/0023433 A1
(43) Pub. Date: Sep. 20, 2001

(54) Information delivery system, information providing apparatus, information storage apparatus and information providing method

(75) Inventors: Shigeyasu Natsubori, Yokohama-shi (JP); Toru Imai, Fuchu-shi (JP); Toshiya Takahashi, Matsudo-shi (JP); Tatsuya Zettsu, Yokohama-shi (JP); Shozo Isobe, Kawasaki-shi (JP); Shinya Amano, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/799,547

(22) Filed: Mar. 7, 2001

(30) Foreign Application Priority Data
Mar. 7, 2000 (JP) 2000-062541

(51) Int. Cl. G06F 15/16

(52) U.S. Cl. 709/207

(57) ABSTRACT

A broadcasting station creates a broadcast schedule for broadcasting advertisement information. An information providing apparatus receives the broadcast schedule through a communication network, changes the broadcast schedule based on advertisement rates for broadcasting the advertisement information, and creating a commercial program guide. The commercial program guide is transmitted through a communication network and received by an information storage apparatus. The information storage apparatus automatically records and stores the advertisement information from the broadcasting station based on the received commercial program guide. Also, commercials can be reproduced according to classifications in accordance with the commercial program guide. Thus, it is made possible to automatically record a commercial according to advertisement rates and to display a commercial as desired by a user.

### BACKGROUND OF THE INVENTION

1. Field of the Invention

The present invention relates to an information delivery system, an information providing apparatus, an information storage apparatus and an information providing method suited for delivering TV commercials.

2. Related Art Statement

Conventionally, if a person makes comparison and examination for a product or the like not at a shop but at home before buying the product, he or she adopts a method of viewing product information by articles appearing in magazines and the like, catalogs or through WWW using the Internet. Since it is difficult to know when advertisements provided by various mediums appear before they are put to the public, it is difficult to use the advertisements for product comparison and examination. Likewise, it is difficult to use TV commercials, in particular, having a high publicity effect.

Moreover, if the person watches television at real time, it is often impossible to even get the grasp of a product or the like from a broadcast commercial. Therefore, it is proposed to make a recording reservation of a TV commercial like other TV programs. However, it is difficult to know the date when the TV commercial is broadcast in advance. Besides, even if it is possible to know the broadcast date, a VTR (videotape recorder) can only make a reservation in units of minutes. For that reason, it is difficult to record only a program which is on the air for a time period as short as 15 to 30 seconds. It is also difficult to systematically view a desired commercial when replaying the videotape.

In addition, TV commercials are quite effective to impress products and greatly influence consumers' consumption behaviors. Nevertheless, information available from TV commercials just impress the products or the like and detailed information on the advertised products such as product specifications.

Further, while a sponsor who provides a product or the like wishes viewers' eyes to fall on the commercial of the product as long as possible. However, the commercial is not always put on the air when consumers who want information on the product or the like watch television. Since viewers find unnecessary information only noise, TV commercials are sometimes skipped over when viewing a recorded program.

In this way, conventionally, it is disadvantageously difficult to record a desired TV commercial since a viewer cannot know when and how an advertisement on a desired product is broadcast. Further, since a TV commercial is not broadcast systematically, it is disadvantageously difficult to make full use of a recorded TV commercial even if the commercial can be recorded. Besides, it is not always possible for an advertisement to have a rating enough to correspond to advertisement rates which a sponsor paid for a commercial.

### OBJECT AND SUMMARY OF THE INVENTION

It is an object of the present invention to provide an information delivery system, an information providing apparatus, an information storage apparatus and an information providing method capable of encouraging a TV commercial to be made effective use of by allowing necessary information to record the TV commercial such as dates when the commercial is broadcast and channels in which the commercial is broadcast and detailed information on a product or the like advertised by the commercial to consumers.

It is another object of the present invention to provide an information delivery system, an information providing apparatus, an information storage apparatus and an information providing method enabling a consumer to obtain detailed information on a product or the like.

It is yet another object of the present invention to provide an information delivery system, an information providing apparatus, an information storage apparatus and an information providing method capable of automatically recording a commercial provided to consumers.

It is yet another object of the present invention to provide an information delivery system, an information providing apparatus, an information storage apparatus and an information providing method capable of presenting recorded commercials according to predetermined classifications.

It is yet another object of the present invention to provide an information delivery system, an information providing apparatus, an information storage apparatus and an information providing method capable of facilitating that a commercial can have a rating corresponding to advertisement rates which the sponsor of the commercial paid.

An information delivery system according to the present invention comprises: information delivery unit configured to delivery predetermined information, and for creating a delivery schedule for delivering the predetermined information; information providing unit configured to create a delivery information guide based on the delivery schedule provided by the information delivery unit, the delivery information created by making at least one of a determination of a change in a content of the delivery schedule and a determination of a content of additional information added to the delivery schedule in accordance with at least one of a consideration for delivering the predetermined information by the information delivery unit and a consideration for creating the delivery information guide; and information storage unit configured to receive the delivery information guide from the information providing unit, and for receiving and storing the predetermined information from the information providing unit based on the received delivery information guide.

Further, an information providing apparatus according to the present invention comprises: reception unit configured to receive and store a delivery schedule for delivering predetermined information; delivery information guide creation unit configured to create a delivery information guide based on the delivery schedule, the delivery information guide created by making at least one of a determination of a change in a content of the delivery schedule and a determination of a content of additional information added to the delivery schedule in accordance with at least one of a consideration for delivering the predetermined information and a consideration for creating the delivery information guide; and delivery information guide transmission unit configured to transmit the delivery information guide.

In addition, an information storage apparatus according to the present invention comprises: delivery information guide reception unit configured to receive a delivery information guide based on a delivery schedule for delivering predetermined information, the delivery information guide created by making at least one of a determination of a change in a content of the delivery schedule and a determination of a content of additional information added to the delivery schedule in accordance with at least one of a consideration for delivering the predetermined information and a consideration for creating the delivery information guide; information management unit configured to determine whether to store the predetermined information thus delivered based on the delivery information guide; and delivery information storage unit configured to record and store the predetermined information delivered according to a determination of the information management unit.

Moreover, an information providing method according to the present invention comprises: a processing for delivering predetermined information, and for creating a delivery schedule for delivering the predetermined information; a processing for creating a delivery information guide based on the delivery schedule by making at least one of a determination of a change in a content of the delivery schedule and a determination of a content of additional information added to the delivery schedule in accordance with at least one of a consideration for delivering the predetermined information and a consideration for creating the delivery information guide.

Further, an information providing method according to the present invention comprises: a processing, conducted at a broadcasting station, for creating a broadcast schedule for broadcasting advertisement information; a processing, conducted in an information providing apparatus, for creating a commercial program guide based on the broadcast schedule by making a change and an addition to the broadcast schedule in accordance with at least one of advertisement rates for broadcasting the advertisement information and a profit for creating the commercial program guide; and a processing, conducted in an information storage device, for receiving the commercial program guide transmitted from the information providing apparatus through a predetermined communication network, and for recording and storing the advertisement information from the broadcasting station based on the commercial program guide thus received.

The other features and advantages of the present invention will become readily obvious by the description which follows.

### BRIEF DESCRIPTION OF THE DRAWINGS

FIG. 1 is a block diagram showing one embodiment of an information delivery system according to the present invention;

FIG. 2 is an explanatory view showing the distribution relationship of data or the like on a network shown in FIG. 1;

FIG. 3 is an explanatory view for a business relationship (payment) on the network shown in FIG. 1;

FIG. 4 is a block diagram showing the concrete constitution of a broadcasting station 1 shown in FIG. 1;

FIG. 5 is an explanatory view showing the format of CM broadcast schedule information stored in a CM broadcast schedule storage section 162;

FIG. 6 is a block diagram showing the concrete constitution of an information providing apparatus 4 shown in FIG. 1;

FIG. 7 is an explanatory view showing an example of CM related information managed by a related information management section 153;

FIG. 8 is an explanatory view showing an example of a commercial program guide stored in a commercial program guide storage section 155;

FIG. 9 is an explanatory view showing an example of a modification made by a commercial program guide generation section 154;

FIG. 10 is an explanatory view showing an example of a modification made by the commercial program guide generation section 154;

FIG. 11 is a block diagram showing the concrete constitutions of information storage apparatuses 7A, 7B, . . . in FIG. 1;

FIG. 12 is a flow chart for describing the operation of the embodiment shown in FIG. 1;

FIG. 13 is a flow chart showing a reservation collation processing algorithm (step 4E) in an automatic recording setting algorithm in FIG. 12 in detail;

FIG. 14 is a flow chart showing the automatic recording setting algorithm;

FIG. 15 is an explanatory view showing a recording example of program guides recorded to correspond to recorded commercials;

FIGS. 16A to 16D are explanatory views showing display examples of screen displays;

FIGS. 17A to 17C are explanatory views showing display examples of screen displays;

FIGS. 18A to 18C are explanatory views showing display examples of screen displays;

FIG. 19 is an explanatory view showing a remote controller;

FIG. 20 is an explanatory view showing a remote controller;

FIGS. 21A and 21B are explanatory views showing display examples of screen displays;

FIGS. 22A to 22D are explanatory views showing display examples of screen displays;

FIG. 23 is a block diagram showing an information storage apparatus according to another embodiment of the present invention;

FIG. 24 is an explanatory view showing a personal information management table managed by a user information management section 98 shown in FIG. 23;

FIG. 25 is an explanatory view showing the personal information management table;

FIG. 26 is an explanatory view showing a remote controller;

FIG. 27 is a flow chart for describing the operation of the embodiment shown in FIG. 23;

FIGS. 28A and 28B are explanatory views showing display examples of screen displays;

FIGS. 29A and 29B are explanatory views showing display examples of screen displays;

FIGS. 30A and 30B are explanatory views showing display examples of screen displays;

FIG. 31 is a block diagram showing an information storage apparatus according to yet another embodiment of the present invention;

FIG. 32 is a block diagram showing an information storage apparatus according to yet another embodiment of the present invention;

FIG. 33 is a block diagram showing an information storage apparatus according to yet another embodiment of the present invention;

FIG. 34 is a flow chart for describing the operation of the embodiment shown in FIG. 33; and

FIGS. 35A and 35B are explanatory views for describing the operation of the embodiment shown in FIG. 33.

### DETAILED DESCRIPTION OF THE PREFERRED EMBODIMENTS

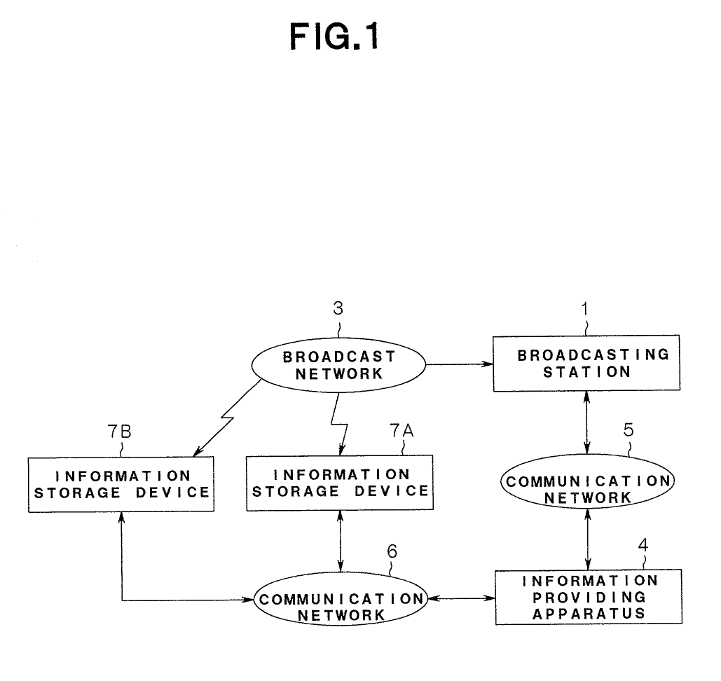

The embodiments of the present invention will be described hereinafter in detail with reference to the accompanying drawings. FIG. 1 is a block diagram showing one embodiment of an information delivery system according to the present invention.

In FIG. 1, a broadcasting station 1 transmits broadcast signals through a broadcast network 3. Each of information storage apparatuses 7A, 7B, . . . provided at respective consumers' sides receives the broadcast signals transmitted through the broadcast network 3 and can display pictures and the like based on the broadcast signals.

In this embodiment, the broadcasting station 1 can communicate data with an information providing apparatus 4 through a communication network 5. The information providing apparatus 4 can communicate data with the information storage apparatuses 7A, 7B, . . . through a communication network 6.

The information providing apparatus 4 may be incorporated into the broadcasting station 1. In that case, the information providing apparatus 4 can also communicate data with the information storage apparatuses 7A, 7B, . . . through the broadcast network 3.

In this embodiment, as will be described later, the information providing apparatus 4 can create information (a commercial program guide) for allowing consumers to make effective use of a commercial broadcast from the broadcasting station 1, and can provide the created information to the information storage apparatuses 7A, 7B, . . . . The information storage apparatuses 7A, 7B, . . . can store the broadcast commercial based on the commercial program guide from the information providing apparatus 4. Further, the information storage apparatuses 7A, 7B, . . . can systematically display the commercial by utilizing the commercial program guide.

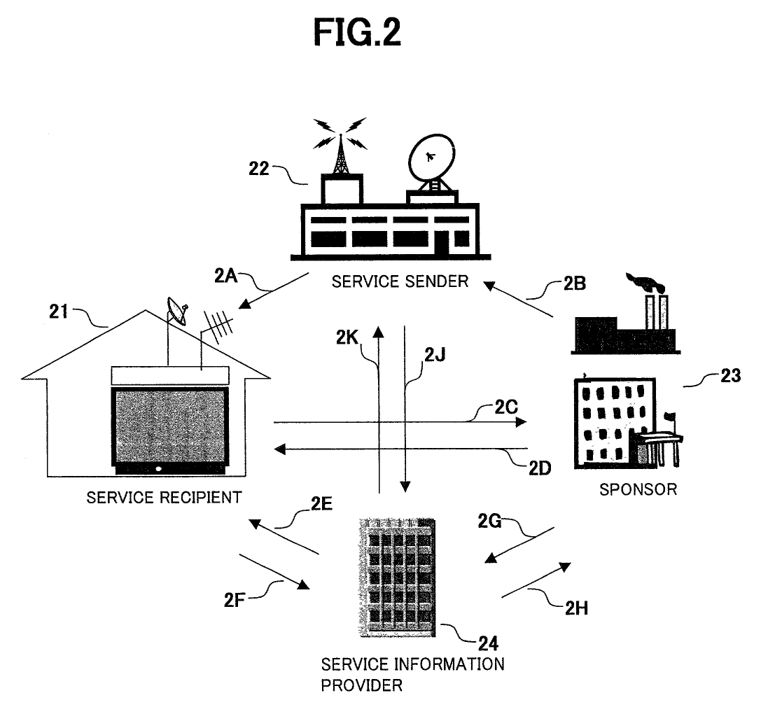

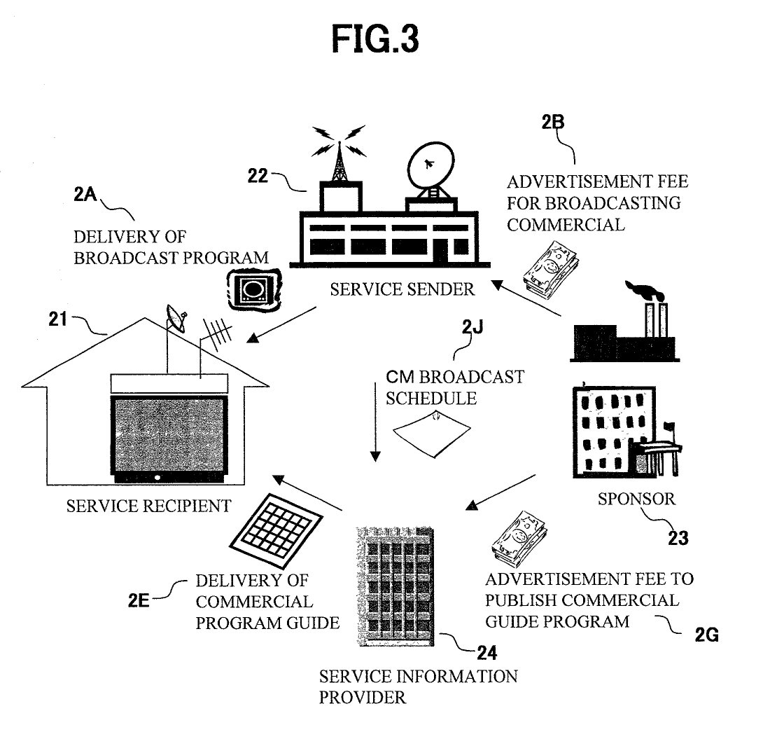

FIG. 2 is an explanatory view showing the distribution relationship of data or the like on a network shown in FIG. 1. FIG. 3 is an explanatory view for describing a business relationship (payments) on the network shown in FIG. 1.

The information storage apparatus 7A, 7B, . . . are owned or installed by service recipients 21 who are service information consumers, i.e., users in ordinary households or the like, respectively. A service sender 22 in FIG. 2 corresponds to the broadcasting station 1 shown in FIG. 1. The broadcast network 3 consists of a broadcast satellite, a communications satellite, a ground wave, a cable or the like. The service sender 22 transmits various types of programs and commercials by unit of broadcast signals.

Information on each commercial transmitted by the service sender 22 is created at the request of a sponsor 23. The sponsor 23 requests the service sender 22 to broadcast a commercial program in the intervals of a TV program for the purpose of the advertisement, announcement, enlightenment and the like of a sponsor's product. In this case, the sponsor 23 pays the service sender 22 advertisement rates (2B). Normally, various conditions such as the broadcast time zones of the commercial, net time for which the commercial is broadcast and the like depend on the advertisement rates (2B).

Each of the service recipients 21 receives and stores a specific information program such as a commercial program by the information storage apparatuses 7A, 7B, . . . . In this embodiment, the information storage apparatuses 7A, 7B, . . . utilize information from the information providing apparatus 4 of the service information provider 24 so as to record and replay a specific information program such as a commercial, i.e., a commercial program guide.

The commercial program guide is directly transmitted from the service information provider 24 to the service recipient 21 (2E) through a telephone line or the Internet serving as the communication network 6 or transmitted to the broadcasting station 1 from the service provider 24 through the communication network 5 (2K). Then, the commercial program guide as well as a broadcast program and the like is indirectly transmitted to the service recipient 21 through the broadcast network 3 (2A).

It is sometimes required, as a condition for providing the commercial program guide, to make a request with consideration to the service information provider 24 for the guide. If the sponsor 23 and the service information provider 24 concluded individual contracts with regard to the sponsor's request of the transmission of the commercial program guide to the service information provider 24 from the sponsor 23, the service provider 24 is paid advertisement rates (2G) according to the content and the like of the transmitted guide.

Further, if the sponsor 23 concluded a blanket contract with the service sender 22 with regard to the request of the transmission of the commercial program guide, then part of the advertisement rates (2B) for broadcasting the commercial is paid to the service information provider 24 as advertisement rates (2J).

As a condition for providing the commercial program guide, it is sometimes unnecessary to make a request with consideration to the service information provider 24. In this case, the commercial program guide is delivered based on the judgment of either the service information provider 24 or the service sender 22. In some cases, the service recipient 21 makes a request (2F) to provide the commercial program guide to the service information provider 24. This request is made with or without consideration.

The service information provider 24 obtains data to create the commercial program guide, i.e., information on a schedule for broadcasting the commercial program (CM broadcast schedule information) from the service sender 22 before the commercial is broadcast (2J). If the service recipient 21 views the commercial program and a consumption behavior (2D) such as a purchase occurs, then the sponsor 23 receives a profit (2C) as the consideration of the purchase.

The delivery and reception of a service will be briefly described. Namely, as shown in FIG. 3, the sponsor 23 pays advertisement rates to the service sender 26 (2B) to request broadcasting a commercial. The service sender 22 produces and delivers a broadcast program with the advertisement rates paid and also delivers the commercial (2A). On the other hand, the service information provider 24 acquires broadcast schedule information on the commercial with or without consideration in advance (2J) from the service sender 22, receives a request from the sponsor 23 to output a commercial program guide (2G), and delivers the commercial program guide to the service recipient 21 through the communication line such as a telephone line or the Internet (2E).

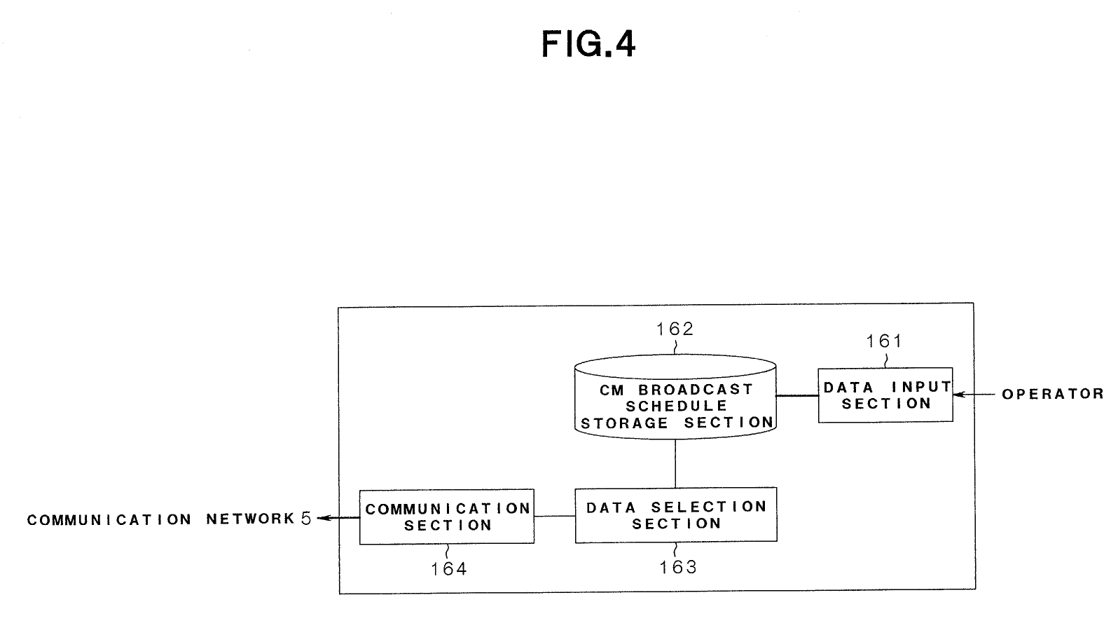

FIG. 4 is a block diagram showing the concrete constitution of the broadcasting station 1 shown in FIG. 1.

The broadcasting station 1 has a function of transmitting pictures or the like through a medium (communication network 3) such as a cable. The constitution of conducting a transmission processing to the broadcast network 3 is the same as that of the existing system and will not be, therefore, shown in FIG. 4 and described herein.

A data input section 161 has a keyboard or the like which is not shown, and inputs a CM broadcast schedule by the operator's operation of the keyboard or the like. A CM broadcast schedule storage section 162 stores CM broadcast schedule information inputted by the data input section 161.

The storage section 162 consists of, for example, a hard disk and stores a file system which can be used on a computer. Namely, the storage section 162 creates and stores CM broadcast schedule information as one file for each broadcast date. The CM broadcast schedule information file includes information on the commercial program corresponding to the order in which the CM is broadcast at the broadcast date.

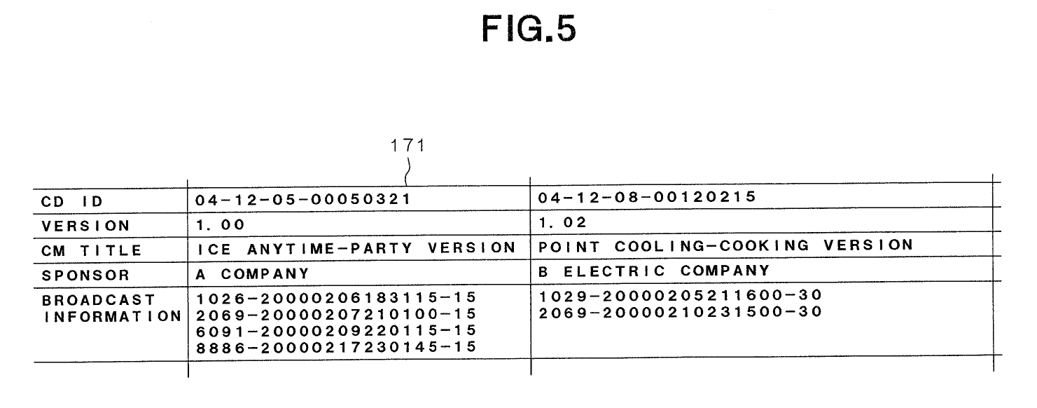

FIG. 5 is an explanatory view showing a CM broadcast schedule information format stored in the CM broadcast schedule storage section 162.

As shown in FIG. 5, the CM broadcast schedule information has regions according to respective commercials (columns in FIG. 5). In each column shown in FIG. 5, a CM ID provided to only one CM in at least the system, version information to be changed if a different version occurs to the same commercial, a commercial title (CM title) which becomes an index when a user identifies the commercial, a sponsor showing the name of a company, an organization or the like which requests the broadcasting of the commercial, and broadcast information which is the list of indexes representing the broadcast dates and channels of the commercial in a predetermined format are described.

In the example of FIG. 5, a column 171, for example, shows that for a commercial with a CM ID of “04-12-05-00050321”, a version of “1.00”, a CM title of “Ice anytime - Party version”, an sponsor of “A Company”, broadcast information of “1026-20000206183115-15”, . . . , . . . , are set. The broadcast information can indicate the broadcast dates, broadcast channels and the like of this commercial.

A date selection section 163 selects to-be-transmitted data from the data stored in the CM broadcast schedule storage section 162. For example, while recording the last date when the CM broadcast schedule was transmitted, a file recorded on the CM broadcast schedule section 162 later than the last date may be selected.

A communication section 164 transmits the data selected by the data selection section 163 to the information providing apparatus 4 of the service information provider 24. The data from the communication section 164 is supplied through the communication network 5 to the information providing apparatus 4. Any medium such as a dedicated line, a telephone line or broadcasting is available as the communication network 5.

The communication section 164 may adopt a data transmission format of sequentially transmitting character strings which is the contents of each CM broadcast schedule information shown in FIG. 5 following the name of the selected file as they are or of encrypting and then transmitting the character strings and the name of the selected file. Alternatively, the communications section 164 may compress the CM broadcast schedule information to thereby reduce the quantity of data.

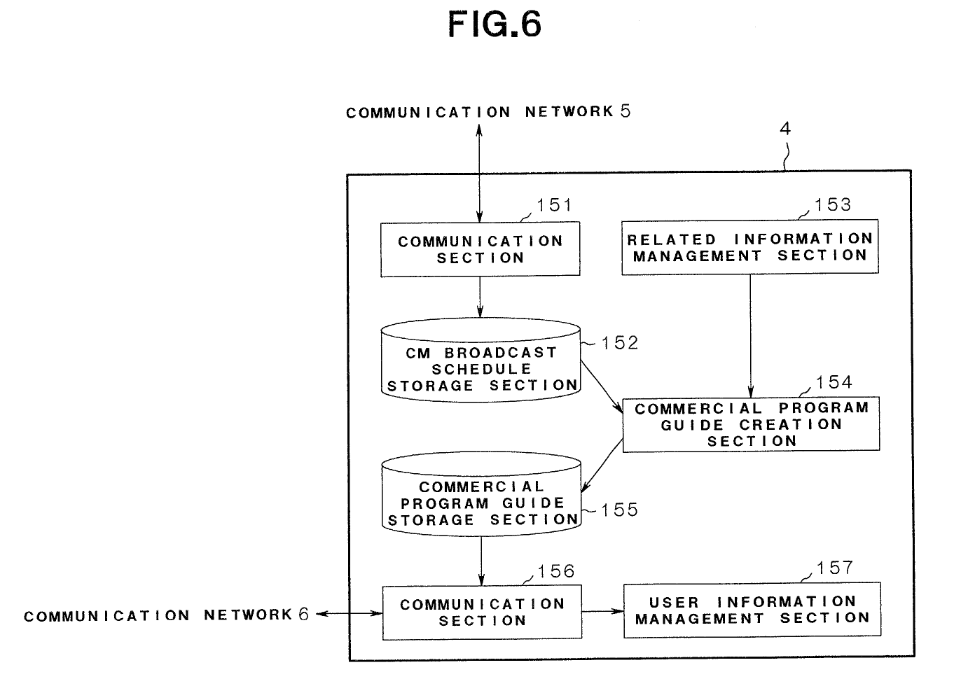

FIG. 6 is a block diagram showing the concrete constitution of the information providing apparatus 4 shown in FIG. 1.

A communication section 151 communicates with the communication section 164 of the broadcasting station 1 and receives the CM broadcast schedule information (see FIG. 5) created by the service sender 22 through the communication network 5.

A CM broadcast schedule storage section 152 stores the CM broadcast schedule information received by the communication section 151. For example, the CM broadcast schedule storage section 152 may create a file having an equal name to that of the received file and record character strings as the content of each CM broadcast schedule information in the file thus created.

A related information management section 153 manages CM related information added to the CM broadcast schedule information received from the broadcasting station which is the service sender 22 and stored in the CM broadcast schedule storage section 152.

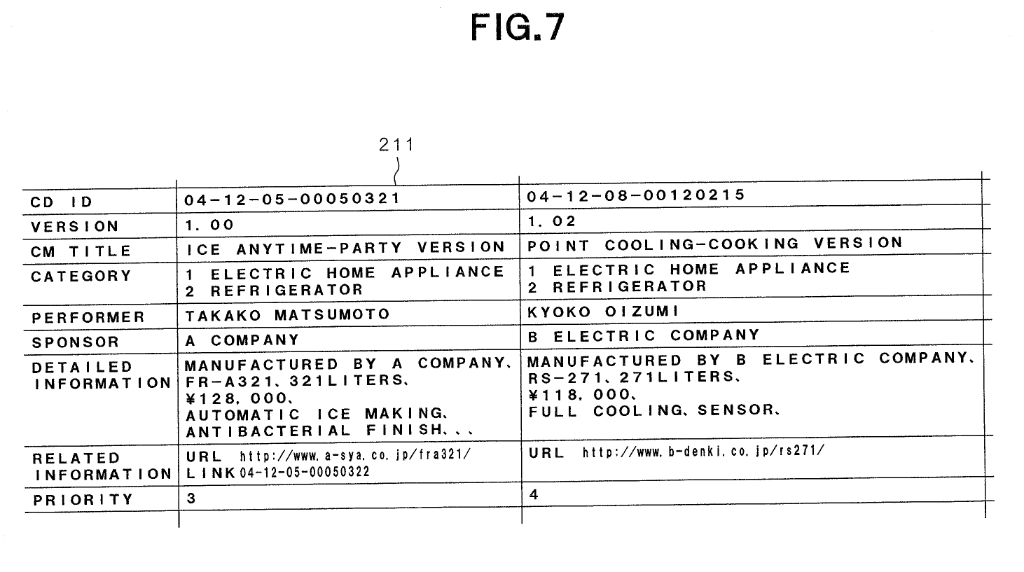

FIG. 7 is an explanatory view showing an example of the CM related information managed by the related information management section 153.

The related information management section 153 manages CM related information on a commercial, for example, supplied either online or offline from the sponsor 23. As shown in FIG. 7, the CM related information managed by the related information management section 153 has regions according to respective commercials (columns shown in FIG. 7). In each column, a CM ID, version information, a commercial title (CM title) and information on a CM sponsor are described as in the case of FIG. 5. Also, a hierarchically described category or a plurality of categories used to classify a commercial target product and other target products, a performer such as the name of an actor or actress who appears on the commercial, detailed information such as the specification and feature of the product, provided by the sponsor or the like so as to let consumer know of the product in more detail, related information showing a URL indicating the WWW site of the commercial product, the locations, indexes and the like of the related information sources of the commercial such as CM ID's of a series of commercials if the commercial belongs to the series of commercials, and the definition of priorities of not only commercials but also other broadcast programs in the system, i.e., priority information systematically used in the system, are described.

In this embodiment, the related information management section 153 also manages information on CM ID's, versions, CM titles and sponsors. As long as these pieces of information correspond to the CM broadcast schedule information transmitted from the broadcasting station 1, the related information management section 153 may manage only the information on, for example, CM ID's, CM titles and the like among the information included in the CM broadcast schedule information.

The example of a column 211 shown in FIG. 7 corresponds to the information described on the column 171 shown in FIG. 5. The same information on the CM ID, the CM version, the CM title and the sponsor as that shown in FIG. 5 are described on the column 211 in FIG. 7. Moreover, on the column 211 shown in FIG. 7, “1: Electric home appliance 2: Refrigerator” is described as a category, which indicates that the Class 1 category of the commercial is electric home appliance and the Class 2 category thereof is refrigerator, a performer of “Takako Matsumoto” is shown, information of “FR-A321, 321 liters, 128,000 yen, 3 doors, automatic ice making, antibacterial finish, . . . ” is shown as detailed information and “URL http://www.a-sya.co.jp/fra321/ LINK 04-12-05-00050322” is shown as related information, and the priority of “3”, is shown as that of the commercial.

A commercial program guide creation section 154 adds the CM related information managed by the related information management section 153 to the CM broadcast schedule information stored in the CM broadcast schedule storage section 152, and creates a commercial program guide to be provided to the service recipient 21.

Namely, the commercial program guide creation section 154 searches for data coincident with the CM broadcast schedule information in CM ID and version from the data managed by the related information management section 153 shown in FIG. 7. Then, based on the values of the respective items in the CM related information, information on broadcast dates and the like is added to the CM broadcast schedule information coincident in CM ID or the like to thereby create a commercial program guide and records the created commercial program guide on the commercial program guide storage section 155.

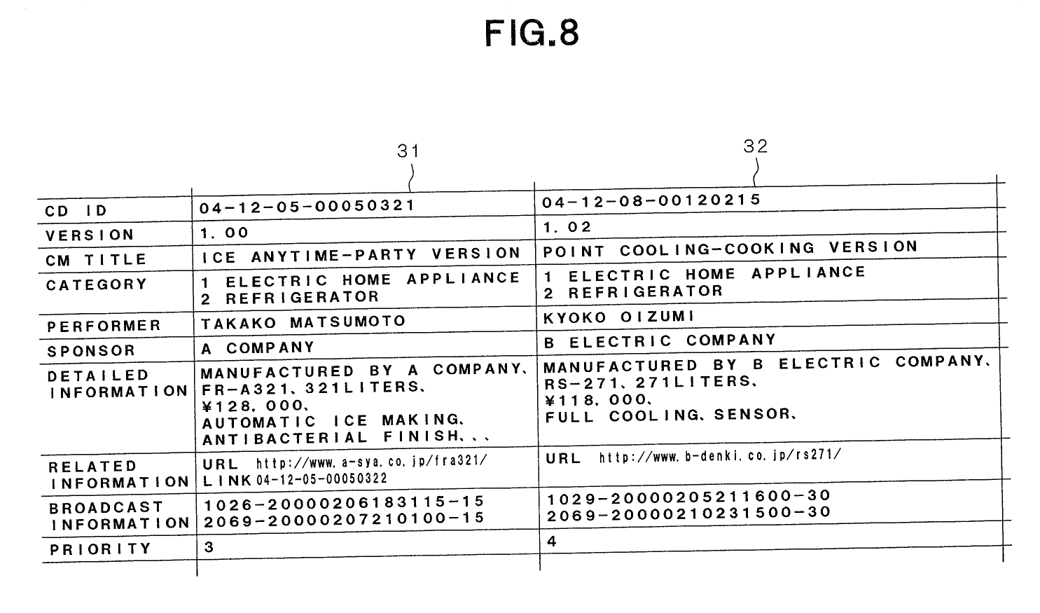

FIG. 8 is an explanatory view showing an example of the commercial program guide stored in the commercial program guide storage section 155.

As shown in FIG. 8, the commercial program guide has regions according to respective commercials (columns in FIG. 8). In each column, a CM ID, version information, a commercial title (CM title), category, a performer, a sponsor, detailed information, related information, broadcast information and priority information are described as in the case of FIGS. 5 and 7.

On a column 31 shown in FIG. 8, for example, “1026-20000206183115-15 2069-20000207210100-15” is described as broadcast information. This broadcast information is a list of indexes described in a preset format and representing the broadcast dates and channels of a commercial. The number, order and the like of indexes described therein are set separately.

A user information management section 157 has user information describing a pair of a user's identifier registered with which this system is available and a password. A communications section 156 refers to the user information held in the user information management section 157 and transmits the commercial program guide stored in the commercial program guide storage section 155 to the information storage apparatuses 7A, 7B, . . . of the respective service recipients 21 through the communication network 6. Any mediums including a telephone, the ISDN, radio and the like are available as the communication network 6.

The commercial program guide can be provided from the information providing apparatus 4 to the information storage apparatuses 7A, 7B, . . . in the same manner as the transmission of data from a WWW server to WWW clients. Namely, each service recipient 21 transmits a user identifier and a user password to the information providing apparatus 4 of the service information provider 24. The communication section 156 of the information providing apparatus 4 receives the data transmitted from the user, and the user information management section 157 collates the received data with the recorded data. If the both data are coincident in user's identifier and password, the communication section 156 transmits the commercial program guide to the information storage apparatuses 7A, 7B, . . . .

In the example of FIG. 6, the CM broadcast schedule storage section 152 and the commercial program guide storage section 155 are constituted separately. Alternatively, storage equipment physically, exactly the same as each other may be used for these sections.

Further, the CM broadcast schedule information provided by the broadcasting station 1 may be intended only for commercials provided from one service sender 22 or for commercials provided from a plurality of service senders 22.

In this embodiment, the commercial program guide creation section 154 creates a commercial program guide in accordance with a contract between the sponsor 23 and the service sender 22 or between the sponsor 23 and the service information provider 24. For example, the commercial program guide creation section 154 modifies the content of the commercial program guide depending on contract rates advertisement rates) paid by the sponsor 23 to either the service sender 22 or the service information provider 24 at the time of concluding the contract.

For example, the commercial program guide creation section 154 modifies the content of the commercial program guide depending on information on the contract inputted manually by an operator or transmitted online in accordance with the contract.

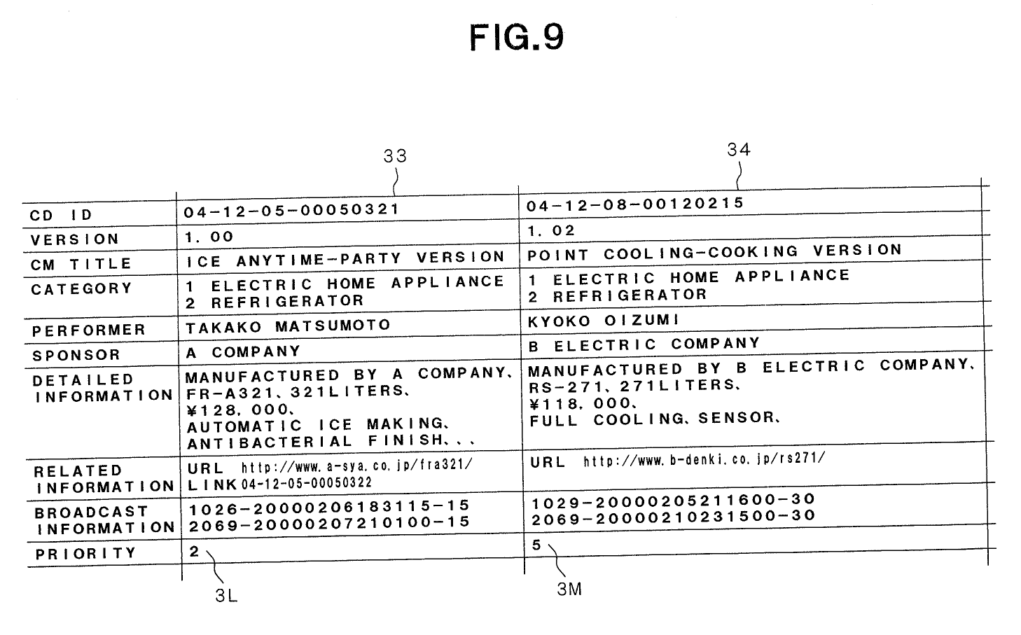

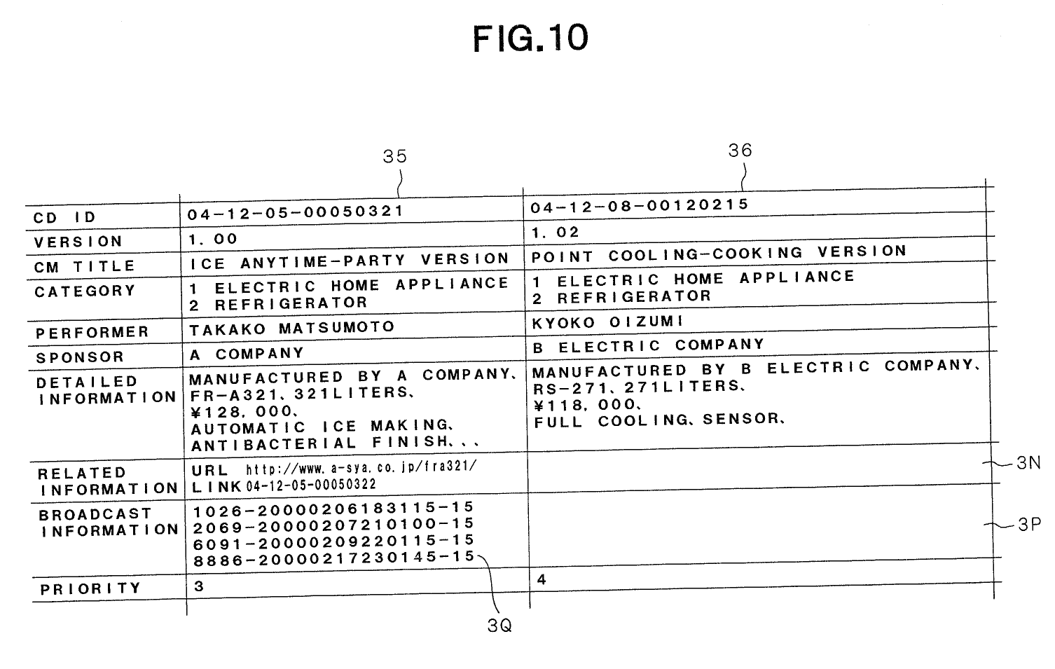

FIGS. 9 and 10 show examples of modification made by the commercial program guide program creation section 154. The commercial program guides shown in FIGS. 9 and 10 correspond to FIG. 8.

FIG. 9 shows a case where contract rates (advertisement rates) at the time of creating the commercial program guide shown in FIG. 8 is changed.

It is now assumed that A Company which is the sponsor 23 increases advertisement rates for the commercial shown on the column 31 of FIG. 8 and that B Electric Company decreases advertisement rates for the commercial shown on the column 32 of FIG. 8. In this case, the commercial program guide creation section 154 modifies priorities according to the advertisement rates, respectively. As for the commercial on the column 31 of A Company which increases the advertisement rates, the commercial program guide creation section 154 increases the priority of the commercial to “2” as shown in item 3L on the column 33 of FIG. 9. As for the commercial on the column 32 of B Electric Company which decreases the advertisement rates, the section 154 decreases the priority of the commercial to “5” as shown in item 3M on the column 34.

The priority can be made to correspond to a commercial recording probability by each of the information storage apparatuses 7A, 7B, . . . as will be described later. If the priority of a commercial is higher (numeric value is lower), there is a higher probability that the commercial can be recorded by the service recipients 21 side. Thus, it is possible to provide information according to advertisement rates.

Further, FIG. 10 shows a case where broadcast information and related information are modified according to advertisement rates. As shown in FIG. 5, more broadcast information than those shown in FIG. 8 are described in the CM broadcast schedule information on which the commercial program guide is based. The commercial program guide creation section 154 describes broadcast information indicating broadcast time by as much as the degree of the advertisement rates. As for the commercial on the column 31 of A Company which increased the advertisement rates, the commercial program guide creation section 154 increases the number of broadcast information as shown in item 3Q on the column 35 of FIG. 10. As for the commercial on the column 32 of B Electric Company which decreased the advertisement rates, the section 154 deletes the items of related information and broadcast information as shown in item 3N, 3P on the column 36.

For example, the broadcast information can be used by the information storage apparatuses 7A, 7B, . . . as information on time for which the commercial is recorded as will be described later. The broadcast information on the commercial of B Electric Company for which the item 3P is deleted is not, therefore, described and related information is inaccessible.

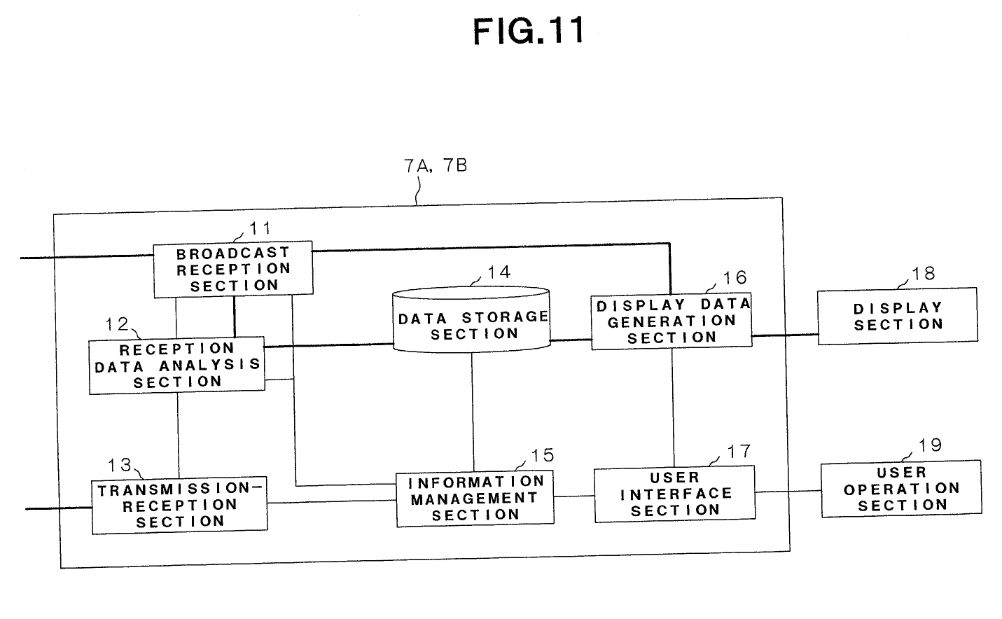

FIG. 11 is a block diagram showing the concrete constitution of each of the information storage apparatuses 7A, 7B, . . . in FIG. 1. The information storage apparatuses 7A, 7B, . . . have the same constitution.

Broadcast data transmitted through the broadcast network 3, i.e., standard moving picture and voice data on a digital or analog broadcast program are inputted into the broadcast reception section 11 of each of the information storage apparatuses 7A and 7B. The broadcast reception section 11 receives the inputted broadcast data and outputs the broadcast data to a display data generation section 16. The display data generation section 16 converts the received broadcast moving picture and voice data into data in a displayable data and signal format and outputs the converted data to a display section 18.

The display section 18 projects pictures based on the inputted data and outputs voice. In this way, by directly supplying the reception data of the broadcast reception section 11 to the display data generation section 16, it is possible to view and listen to the broadcast program at real time.

The broadcast data received by the broadcast reception section 11 can be supplied to a data storage section 14 through a reception data analysis section 12, and recorded and stored in the data storage section 14. The reception data analysis section 12 analyzes the reception data received by the broadcast reception section 11 and supplies a program which recording is designated by an information management section 15 to the data storage section 14. The data storage section 14 is controlled by the information management section 15 to record and store the reception data. The data storage section 14 is also controlled by the information management section 15 to read the recorded, stored data and to output the read data to the display data generation section 16.

Normally, if a broadcast program is recorded, the recording can be easily conducted by using an electronic program guide (EPG) or the like included in a broadcast signal or the like. Further, if scheduled broadcast time or the like is known in advance like an ordinary broadcast program, the recording of the program can be reserved by user's designation of the time, a broadcasting station or the like.

A user operation section 19 outputs a signal based on a user's operation to a user interface section 17. The user interface section 17 outputs the signal based on the user's operation to the display data generation section 16 and, at the same time, to the information management section 15. This enables the information management section 15 to control the reception data analysis section 12 and the data storage section 14 in accordance with a user's recording reservation operation to reserve the recording of the program designated by the user.

However, there are some programs such as a commercial for which it is quite complicated to make a user's manual setting because of the fact that it is difficult to know a scheduled broadcast time or the like in advance or that many short-time programs exist. In this embodiment, to record such a commercial, the commercial program guide delivered by the information providing apparatus 4 of the service information provider 24 is used.

The transmission and reception section 13 of each of the information storage apparatuses 7A, 7B, . . . receives the commercial program guide delivered from the information providing apparatus 4 through the communication network 6. The received commercial program guide is supplied to the reception data analysis section 12.

If the commercial program guide is transmitted as additional information data or independent information data on the broadcast program synchronously or asynchronously with moving picture and voice data standard as a broadcast signal from the broadcasting station 1, then the commercial program guide received by the broadcast reception section 11 is supplied to the reception data analysis section 12.

The reception data analysis section 12 analyzes the inputted commercial program guide and stores the analyzed commercial program guide in a predetermined format in the data storage section 14. The reception data analysis section 12 also supplies the broadcast information in the commercial program guide to the information management section 15. The information management section 15 appropriately sets the broadcast reception section 11, the data analysis section 12 and the data storage section 14 at the scheduled time designated by the broadcast information, thereby automatically recording the corresponding commercial.

Further, the information management section 15 controls the reading of the commercial program recorded on the data storage section 14 in accordance with a user's operation by using the commercial program guide recorded on the data storage section 14, and allows diversified display forms in the display data generation section 16.

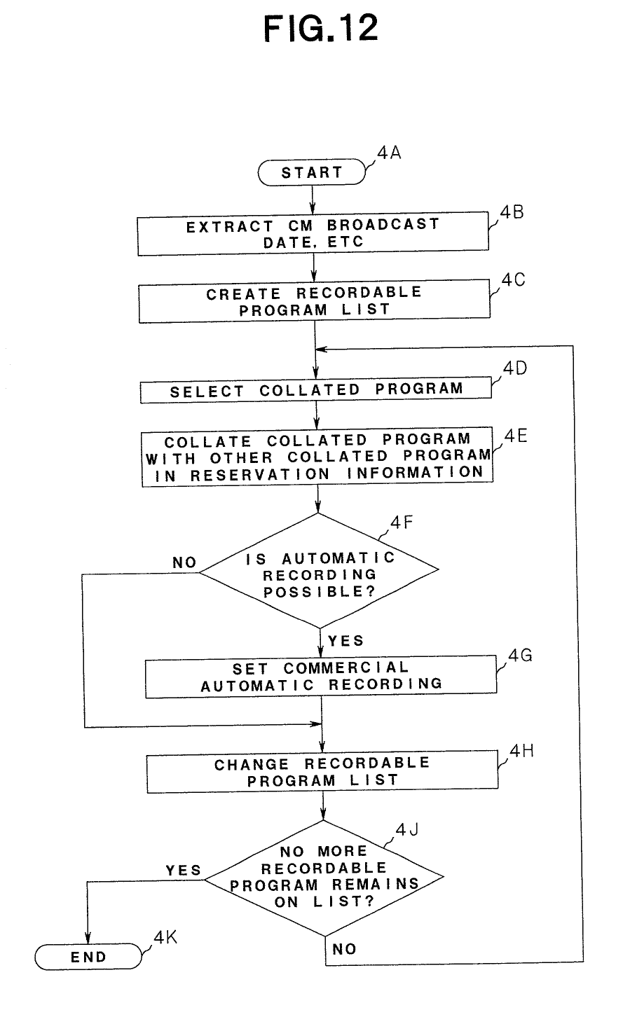

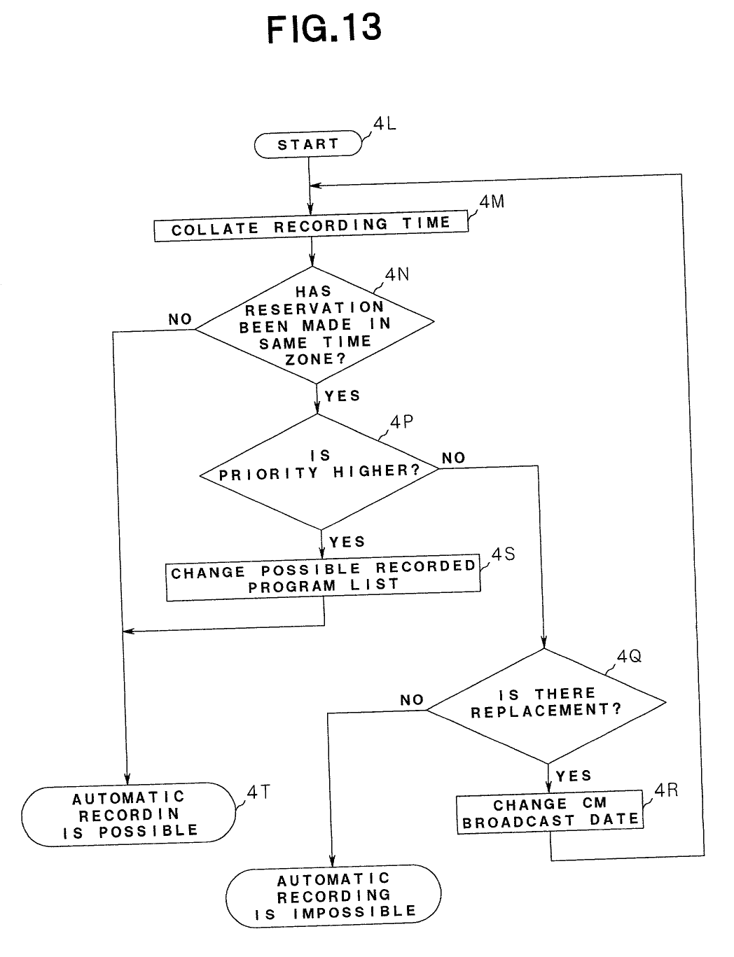

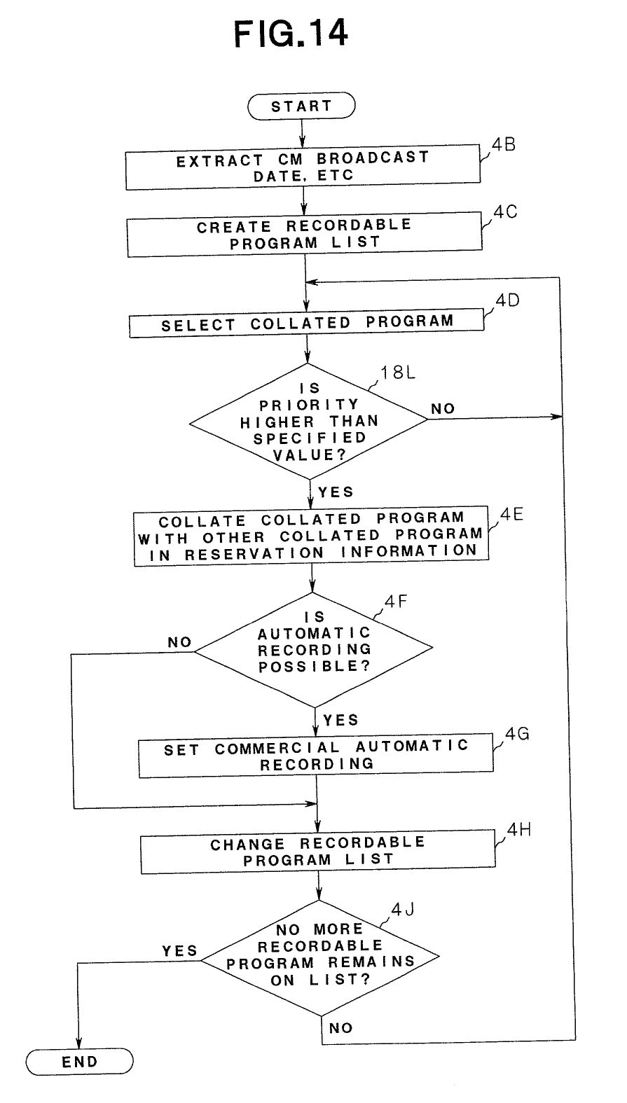

Next, the operation of this embodiment constituted as stated above will be described with reference to flow charts shown in FIGS. 12 and 13 as well as FIGS. 14 to 22D.

By the request of the sponsor 23, the broadcasting station 1 serving as the service sender creates a commercial. It is now assumed that the broadcast schedule for the commercial televised by the broadcasting station 1 is that shown in FIG. 5. The broadcasting station 1 transmits the CM broadcast schedule information shown in FIG. 5 to the information providing apparatus 4 of the service information provider 24.

The information providing apparatus 4 receives the CM broadcast schedule information at the communication section 15 and stores the received CM broadcast schedule information in the CM broadcast schedule storage section 152. The related information management section 153 manages CM related information on each commercial supplied from the sponsor 23. The commercial program guide generation section 154 compares the CM broadcast schedule information received by the communication section 151 with the CM related information managed by the related information management section 153, adds the CM related information to the CM broadcast schedule information for a corresponding commercial and thereby generates a commercial program guide.

In this case, the commercial program guide generation section 154 changes priority, the broadcast information and the like properly in accordance with, for example, advertisement rate.

The generated commercial program guide is stored in the commercial program guide storage section 155. The communication section 156 reads the corresponding commercial program guide from the storage section 155 and delivers the read commercial program guide to the information storage apparatuses 7A, 7B, . . . serving as the service recipients based on the user information managed by the user information management section 157 before the commercial is broadcast at the broadcasting station 1.

Each of the information storage apparatuses 7A, 7B, . . . receives the broadcast data through the broadcast network 3 from the broadcasting station 1. The commercial program guide is, by contrast, directly transmitted to the information storage apparatuses 7A, 7B, . . . through the communication network 6 from the information providing apparatus 4 or transmitted thereto through the communication network 5, the broadcasting station 1 and the broadcast network 3 from the information providing apparatus 4.

The commercial program guide transmitted through these transmission lines is supplied to and analyzed by the reception data analysis section 12 of each of the information storage apparatuses 7A, 7B, . . . . Commercial program guide data is stored in a predetermined format in the data storage section 14, while broadcast information in the commercial program guide is also supplied to and managed by the information management section 15.

The information management section 15 judges a commercial broadcast time based on the broadcast information. When scheduled broadcast time arrives, the information management section 15 controls the broadcast reception section 11, the data analysis section 12 and the data storage section 14 to automatically record the commercial.

Various algorithms for setting automatic commercial recording may be proposed. FIG. 12 shows one example of these algorithms.

When receiving the commercial program guide regularly or irregularly, the information management section 15 extracts broadcast information and priority information, such as the broadcast dates of the commercial, related to the recording of the commercial (in a step 4B), and creates a recordable program list of respective commercial programs and broadcast programs for which broadcast programs recording reservations are already made (in a step 4C).

Next, one of the recordable programs described on the created recordable program list is selected from the list (in a step 4D) , and the selected recordable program (first collated program) is collated with another recordable program (second collated program) with respect to information necessary for recording reservations such as recording time and channels (in a step 4E).

FIG. 13 shows the detail of an algorithm for a reservation collation processing (step 4E) in the automatic recording setting algorithm shown in FIG. 12.

As shown in a step 4M in FIG. 13, the information management section 15 collates one possible broadcast time of the second collated program with the broadcast time of the first collated program. If the recording of the first collated program was already reserved, the information management section 15 collates the possible broadcast time of the second collated program with the determined time. If the recording thereof is not set yet, the information management section 15 collates one possible broadcast time of the second collated program with the possible recording time of the first collated program. It is noted that a selection method for recordable time and possible broadcast time is determined separately.

If it is found by the collation processing that the two programs are not reserved in the same time zone, then the selected possible broadcast time of the second collated program can be determined as the recording time of the program (in step 4T). If it is found by the collation processing that the two programs are reserved in the same time zone, priority comparison is made between the first and second collated program (in a step 4P).

If the priority of the second collated program is higher than that of the first collated program, the state of the first collated program which recording is already determined is changed into a state in which no recording setting is made (in a step 4S) and the recording time of the second collated program is determined at the selected broadcast time. Conversely, if the priority of the second collated program is lower than that of the second collated program, possible broadcast time other than the currently selected possible broadcast time of the second collated program is selected (in a step 4R) and a collation processing is conducted again.

Normally, a commercial is broadcast a plurality of times. Therefore, broadcast time for which recording is not reserved may be selected from among a plurality of possible broadcast time of the second collated program. Thereafter, the same procedures are repeated. If no possible broadcast time of the second collated program is eventually present (in a step 4Q), it is judged that the second collated program cannot be automatically recorded.

If it is judged that automatic recording is possible by the above-stated reservation collation processing, a recording reservation for the selected program is set in a step 4G in FIG. 12. If it is judged that automatic reservation is impossible by the reservation collation processing, a recording reservation setting is not made for the second collated program.

Next, the information management section 15 changes the combination of the collated programs (in a step 4H), and repeats the same operations as long as there remains a recordable program on the list (in a step 4J).

As can be seen from the above, in this embodiment, the CM related information from the sponsor is added to the schedule information on the commercial broadcast by the broadcasting station and a commercial program guide changed depending on the advertisement rates or the like paid by the sponsor is created. By delivering the created commercial program guide to consumers, the information storage apparatus of each consumer can automatically store the broadcast commercial. Further, the commercial program guide has information according to the advertisement rates or the like of the sponsor and it is, therefore, possible to control commercial recording probability according to the advertisement rates for the commercial.

Meanwhile, in the example of FIG. 12, if there are plurality of recordable commercials, the priorities of the respective commercials are used to determine which commercial is to recorded. However, the use of priorities should not be limited to the example of FIG. 12.

For example, there is also a priority using method wherein a commercial having a low priority is not recorded even if reservations are not overlapped. FIG. 14 is a flow chart showing an automatic recording setting algorithm in this case. In FIG. 14, the same procedures as those in FIG. 12 are denoted by the same reference symbols and will not be described herein.

The operation flow of FIG. 14 differs from that of FIG. 12 in that the priority of the commercial program guide is examined in a step 18L and a commercial is set as a recordable program if the priority is lower than a specified value (the priority is higher than the specified value). This specified value may be a preset value, may be changed according to the empty region of the recording capacity of a recording equipment, or may be set by a user. It is noted that the detailed algorithm of the step 4E is the same as that show in FIG. 13.

In this way, picture and voice data on commercial programs are automatically recorded and stored, and the relationship of the picture and voice data with the corresponding information described in the commercial program guide is managed by the information management section 15.

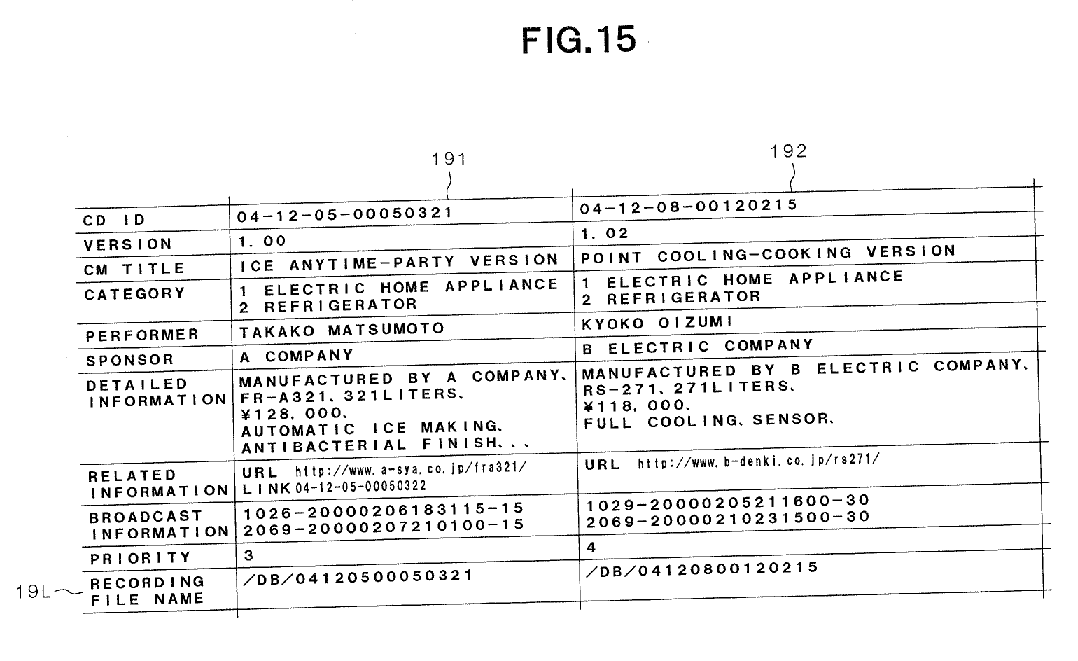

FIG. 15 is an explanatory view showing a recording example of a program guide recorded to correspond to a recorded commercial.

The program guide is created based on the commercial program guide provided from the service information provider 24. For example, if each of the information storage apparatuses 7A, 7B, . . . receives the commercial program guide shown in FIG. 8, the information management section 15 thereof creates a program guide shown in FIG. 15 and stores the created program guide in the data storage section 14.

The program guide shown in FIG. 15 differs from the commercial program guide shown in FIG. 8 in that an item 19L is added. The item 19L is a column in which the recording file name of the commercial is described if the corresponding commercial is recorded. When recording and storing the commercial program, the information management section 15 allots a recording file to the commercial program and stores the commercial program in the file. The file name in that case is described in the item 19L.

Further, in this embodiment, the information management section 15 makes it possible to effectively view the commercial stored in the storage section by utilizing the program guide stored in the data storage section 14.

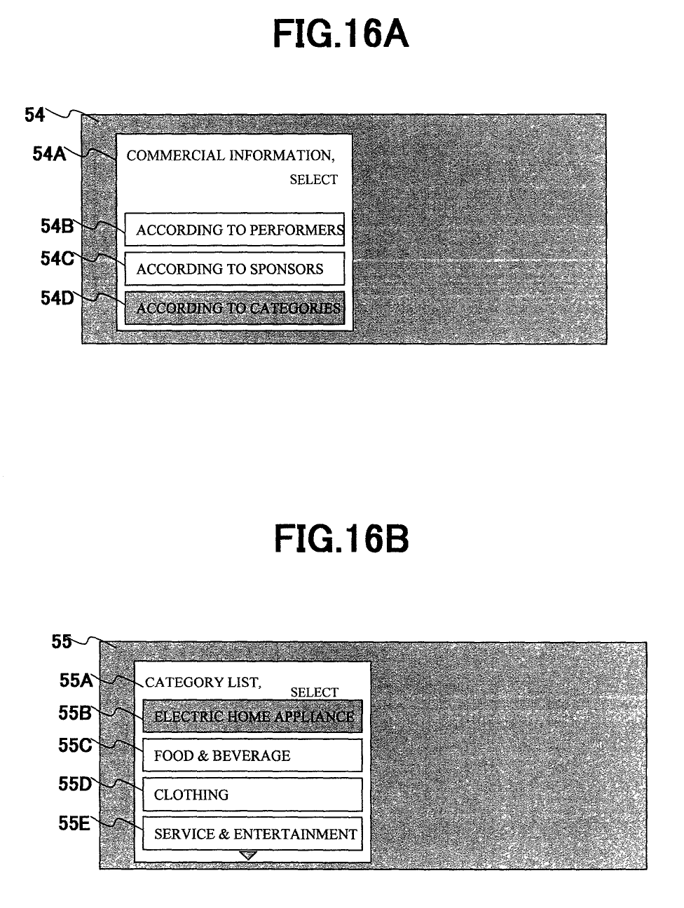

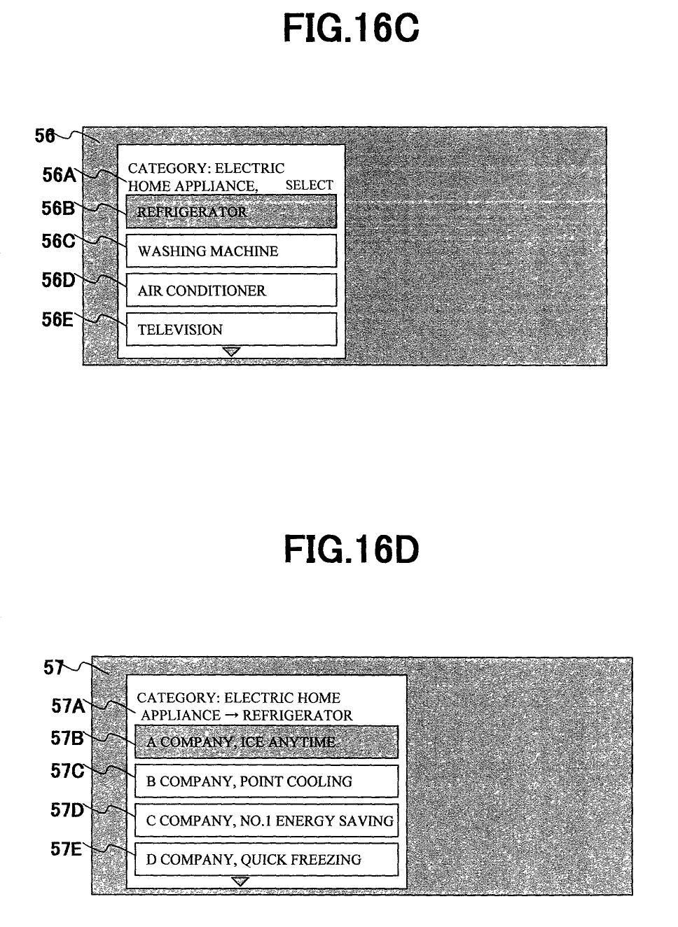

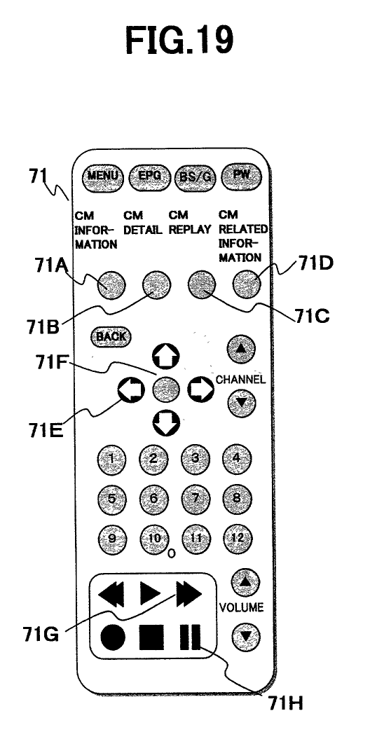

Next, an operation flow until a viewer views and listens to commercial information will be described with reference to explanatory views shown in FIGS. 11 and 16A to 19. FIGS. 16A to 18C show display examples of a screen by the display section 18. FIG. 19 shows a remote controller which is an example of the user operation section 19. The user can view and listen to commercial information at appropriate timing by using the remote controller.

The display section 18 is connected to the display device of a television receiver or the like which is not shown, and can project a display based on display data from the display data generation section 16 onto the display device. The user or the service recipient 21 can instructs a commercial to be displayed with the remote controller 71 shown in FIG. 19. The remote controller 71 has various buttons to control each of the information storage apparatuses 7A, 7B, . . . .

For example, if the user depresses a “CM information” button 71, the user interface section 17 receives an instruction based on this operation and the occurrence of the user's instruction to display the commercial information is transmitted to the information management section 15. The information management section 15 outputs a control signal corresponding to the user's instruction to the data storage section 14 to thereby read the commercial data stored in the data storage section 14 and supply the read commercial data to the display data generation section 16.

The display data generation section 16 generates display data suitable for the display section 18. As a result, the display section 18 displays a commercial display 54 shown in, for example, FIG. 16A on the display screen of the display device. On the commercial display 54, three options of “according to performers”, “according to sponsors” and “according to categories” appear.

The display data generation section 16 and the user interface section 17 specify operations of cases where the respective options are displayed and user's selection operations in response to these options are carried out, according to the contents of the displays. For example, if the user carries out a selection operation according to categories by using the remote controller 71, then the user interface section 17 outputs an instruction to the display data generation section 16 to classify and display commercials according to categories. Likewise, if the user carries out a selection operation according to performers or according to sponsors, the user interface section 17 outputs an instruction to the display data generation section 16 to classify and display commercials according to performers or sponsors.

Now, it is assumed that the user wishes to display commercials according to categories. The user sequentially moves a noted position to selected items 54B, 54C and 54D by a cursor key 71E or the like on the remote controller 71 and selects the option according to categories by a determination key 71F on the remote controller. If so, the user's instruction is supplied to the display data generation section 16 through the user interface section 17.

The display data generation section 16 searches for category items of the program guides stored in the data storage section 14, creates a category list and displays the category list display 55 shown in FIG. 16B on the display screen. For example, the display data generation section 16 extracts category items of the stored commercial program guides (FIG. 15), arranges the character strings of the category items and thereby creates the category list display 55.

A down arrow on the lowermost portion of the category list display 55 indicates that four or more commercial categories are stored. If the down arrow is selected, yet another category names are displayed.

Here, it is assumed that the user selects an electric home appliance on the category list display 55. Then, the display data generation section 15 searches for the category items of the recorded program guides, lists commercials in Class 1 of the category “Electric Home Appliance”, and creates a list of Class 2 of the category. The display data generation section 16 displays this list as a category Class 2 display 56 on the screen (FIG. 16C). For example, the display data generation section 16 creates the category Class 2 display 56 by arranging the character strings of category items in Class 2.

A down arrow on the lowermost portion of the category Class 2 display 56 indicates that four or more Class 2 category items are included in the category “Electric Home Appliance”. By selecting the down arrow, the names of the other electric home appliances are displayed as in the case of the category list display 55.

Here, it is assumed that the user selects a sub-category of refrigerator 56B. The display data generation section 16 searches for the stored program guides, lists commercials in Class 1 “Electric Home Appliance” of the category items and in Class 2 “Refrigerator”, arranges the sponsors and CM titles of the commercials, creates and displays a sponsor display 57 on the screen (FIG. 16D). A down arrow on the lowermost portion of the sponsor display 57 indicates that there are four or more options. By selecting the down arrow, the other sponsors can be displayed on the screen.

Needless to say, if there is only one class to be displayed by each of the displays shown FIGS. 16A to 16D described above, the display data generation section 16 may omit the display and display the next option.

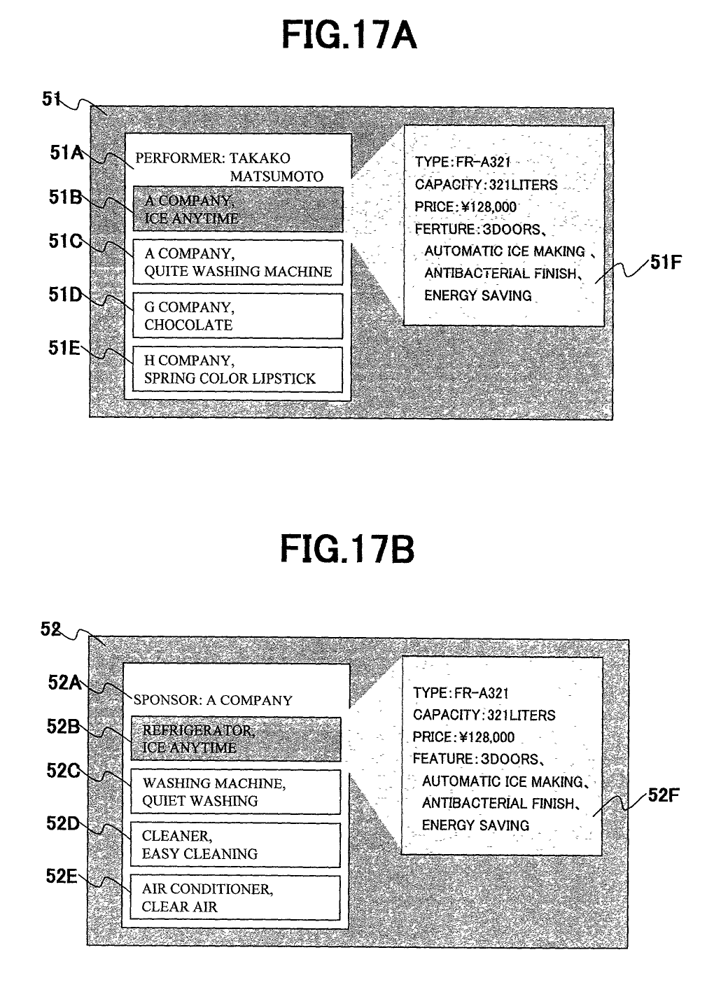

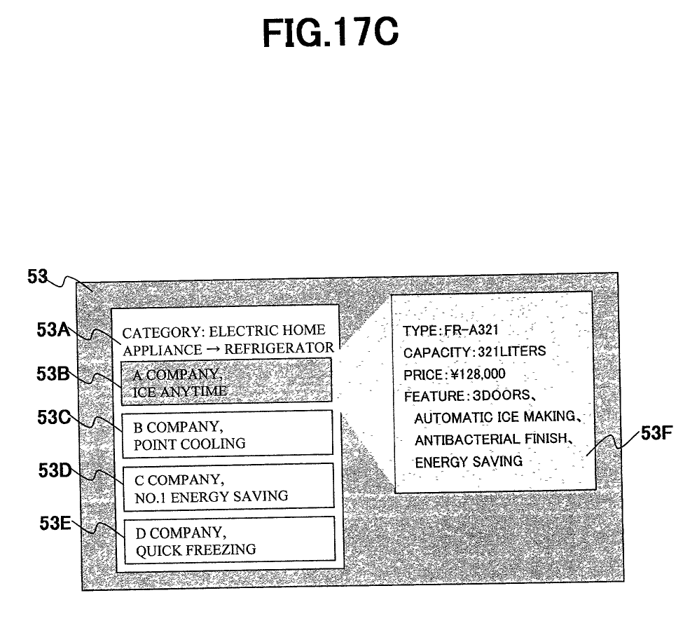

Next, it is assumed that the user depresses a “CM detail” button 71B on the remote controller 71 while “Ice Anytime” in the option 57B is selected. Then, the display data generation section 16 detects a commercial which belongs to Class 1 “Electric Home Appliance” and Class 2 “Refrigerator” of the category item of the program guide, which sponsor is “A Company” and which CM title is “Ice Anytime”, reads a detailed information part, arranges and displays detailed information. FIG. 17C shows a detailed display 53 in this case.

When the user depresses the “CM detail” button 71B on the remote controller 71 again, a window 53F in the detailed display 53 can be closed. The window 53F can be set to be automatically closed or the like after a certain time period passes by operating the button 71B.

The detailed display 53 shown in FIG. 17C can be displayed by using different links from those in FIGS. 16A to 16C. For example, if an option 54B on the commercial display 54 shown in FIG. 16A is selected, the display data generation section 16 searches for program guides, arranges character strings described in the items of performers and displays the character strings on the screen.

In the example of FIG. 15, at least “Takako Matsumoto” and “Kyoko Oizumi” are displayed as options on the screen. In this case, if the user selects “Takako Matsumoto”, the display data generation section 16 creates a screen display on which sponsors and the CM titles for commercials having “Takako Matsumoto” as the performer items from the program guides stored are arranged, and displays the screen display.

On this screen display, at least the option of “A Company Ice Anytime” appears. Here, if the user selects this option and depresses the “CM detail” button 71B, a detailed display 51 shown in FIG. 17C appears. The window 51F on this detailed display 51 is created by acquiring the character strings of the detailed information items in the column 191 shown in FIG. 15.

Further, if an option 54C is selected in the commercial display 54 shown in FIG. 16A, the display data generation section 16 searches for the stored program guides, arranges character strings described in sponsor items and displays a sponsor list (FIG. 17B). Here, if the user selects “A Company”, the display data generation section 16 creates a sponsor display 52 on which Classes 1 and 2 of the category item are arranged, and displays the sponsor display 52. On this display 52, if the user selects “A Company Ice Anytime” and depresses the “CM detail” button 71B, a detailed information window 52F appears on the sponsor display 52 regarding the commercial where “A company” is written in the sponsor item of the accumulated program guides.

If the user depresses a “CM replay” button 71C on the remote controller 71 while the respective detailed displays in FIGS. 17A to 17C appear, then the display data generation section 16 acquires the file of the selected commercial from an item “replay file name”, reads this file from the data storage section 14 and projects the file on the screen.

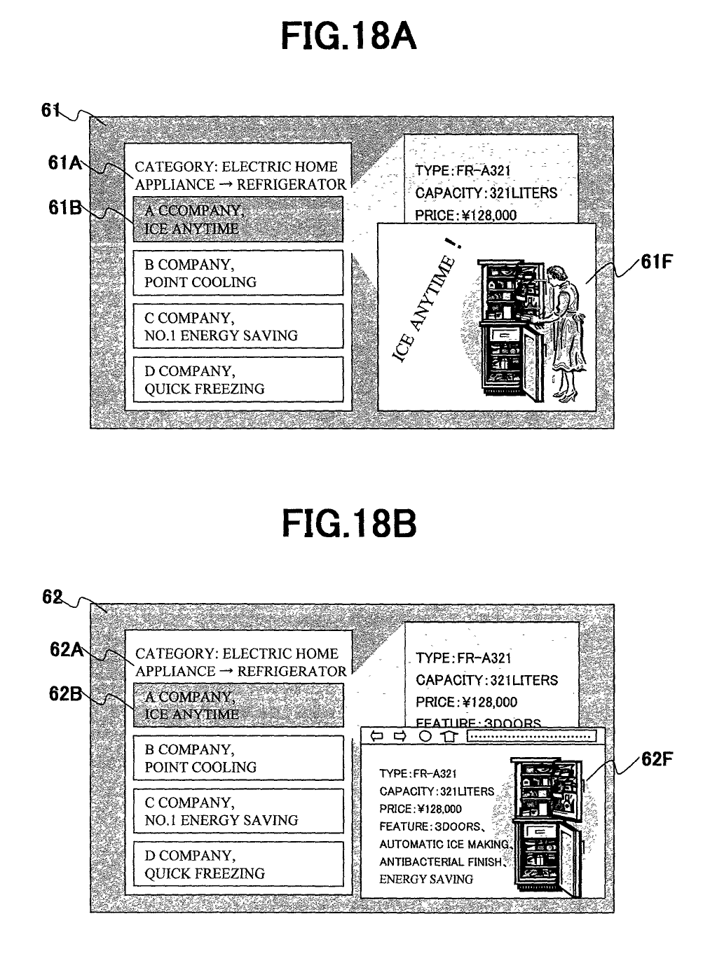

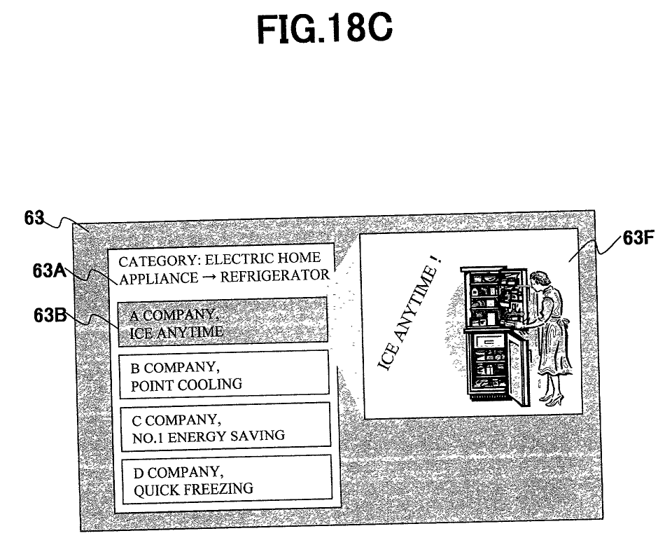

For example, if the “CM replay” button 71C is depressed while the detailed display 53 in FIG. 17C appears, a commercial picture display 61 shown in FIG. 18A appears and a commercial picture is projected in a window 61F. This commercial picture can be replayed in various special manners by the display data generation section 16 as in the case of the contents of other pictures. For example, by operating a quick feed button 71G and a halt button 71H, the commercial picture is quickly fed and halt, respectively. If the “CM replay” button 71C on the remote controller 71 is depressed again, the window 61F is closed. It is also possible to conduct other operations including an operation for closing the window 61F after replaying the commercial picture once or several times and an operation for automatically closing the window 61F after a certain time period passes after finishing replaying the picture, by presetting these operations.

The replay of commercial pictures does not necessarily mean that one commercial picture for one commercial item is replayed. For example, if there are a plurality versions different in the time length of commercial pictures to advertise the same product or the like, it is possible to continuously replay commercial pictures of a plurality of recorded and stored versions. It is also possible to selectively replay commercial pictures by setting a sub-menu on the screen. To replay such commercial pictures, it is necessary to change the automatic recording setting algorithm and/or the description of program guides.

Furthermore, if a “CM related information” button 71D on the remote controller 71 is depressed while the detailed display 53 appears, then the display data generation section 16 creates and displays a related information display 62. On this display 62, a window 62F indicating commercial related information appears. For example, if the display data generation section 16 accesses a URL shown in the related information part of the corresponding program guide, the windows 62F can be displayed. For example, the content of a Web site indicated by the URL described in the program guide is displayed by acquiring the content in advance by using means such as communication or broadcasting, recording and storing the acquired the content in the data storage section 14 or the like, or by connecting the Internet at real time when the button 71D is operated.

It is noted that an operation for viewing a Web site is conducted by moving a site position using the cursor key 71E or the like on the remote controller 71 and selecting the moved position using a determination key 71F on the remote controller 71. Alternatively, another key may be allotted to the remote controller 71 or another operation device may be used WWW browsing. If the user depresses “CM related information” button 71D on the remote controller 71 again, the window 62F is closed. It is also possible to conduct other operations including an operation for automatically closing the window 62F after a certain time period passes by presetting these operations.

The replay of commercial pictures or the display of commercial related information are possible not only after the commercial detailed information is displayed. Also, as shown in the respective displays in FIGS. 17A to 17D, the replay of commercial pictures and the display of commercial related information are possible as long as the commercial is in a selectable state. A commercial picture display 63 is a display which appears when the “CM replay” button 71C on the remote controller 71 is depressed on the sponsor display 57. The commercial picture display 63 is realized if the display data generation section 16 opens and replay the file shown in the recording file name part of the corresponding program guide.

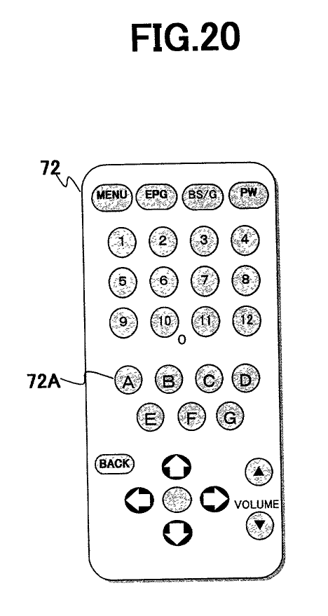

While description has been given to the use of the remote controller 71 having dedicated buttons such as the buttons 71A to 71D shown in FIG. 19 as an example of a remote controller as shown in FIG. 20, a remote controller 72 having universal buttons 72A may be used. If the remote controller 72 is used, it is necessary to display on the screen or the like that how buttons function when respective operations are carried out.

Further, in this embodiment, it is possible to not only display information on a commercial but also execute various processings related to the commercial. For example, it is possible to conduct an order processing for buying a product introduced by the commercial while viewing the display of the commercial.

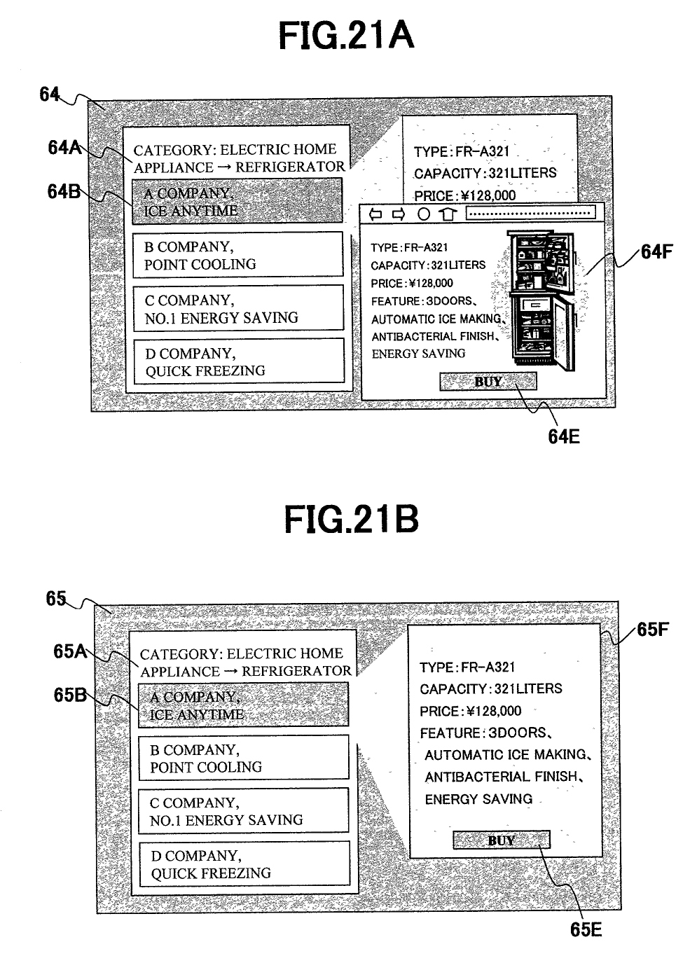

FIGS. 21A and 21B are explanatory views showing screen displays adopted in the order processing.

If the user depresses the “CM related information” button 71D on the remote controller 71 while the detailed display shown in FIG. 17C appears, then the display data generation section 16 displays a related information display 64 shown in FIG. 21A. A window 64F displaying commercial related information appears on the related information display 64. For example, the display data generation section 16 can display the window 64F by accessing a URL shown in the related information part of the corresponding program window.

The user can place an order to buy a product on a Web site shown in the window 64F. If the user clicks on a product purchase button 64F using the cursor key 71E or the like on the remote controller 71, a product purchase processing starts. Information on the product purchase processing is recorded and stored in the data storage section 14 by, for example, the user interface section 17 and the information management section 15, and then an order, a settlement and the like are carried out by differently provided unit. Alternatively, when these instructions are issued, the user connects to the Internet at real time and place an order, makes a settlement and the like.

In this case, the information management section 15 conducts order, settlement and other processings using either the transmission-reception section 13 or an Internet connection section which is not shown.

It is also possible to carry out the product purchase processing using the detailed information. If the user depresses the “CM detail” button 71B on the remote controller 71 while the option 57B “Ice Anytime” on the sponsor display 57 shown in FIG. 16A is selected, then a detailed information display 65 shown in FIG. 21B appears. Using a window 65F displaying detailed information on the display 65, it is possible to carry out the product purchase processing.

Namely, a selection position is moved by using the cursor keys 71E or the like and a product purchase button 65E is selected by the determination key 71F on the remote controller. When the product purchase button 65E is clicked on, a product purchase processing starts. This processing is the same as that shown in FIG. 21A.

In case of carrying on such electronic commerce, it is necessary to do so without letting personal information or the like used for orders and settlements known to the third party or the like. To this end, encryption technology is normally used. If the encryption technology is used, a method of distributing a key for encryption or decryption is important. Taking this into consideration, the transmission-reception section 13 holds communication while using, as the communication network 6, a dedicated line such as a telephone line, thereby making it possible to ensure the safe distribution of the key. Thus, even if a general-purpose line such as the Internet or the like is used, safe electronic commerce can be carried on. Further, a method of storing a key for encryption in each of the information storage apparatuses 7A, 7B, . . . in advance as either a hardware or a software and of using the key, may be available.

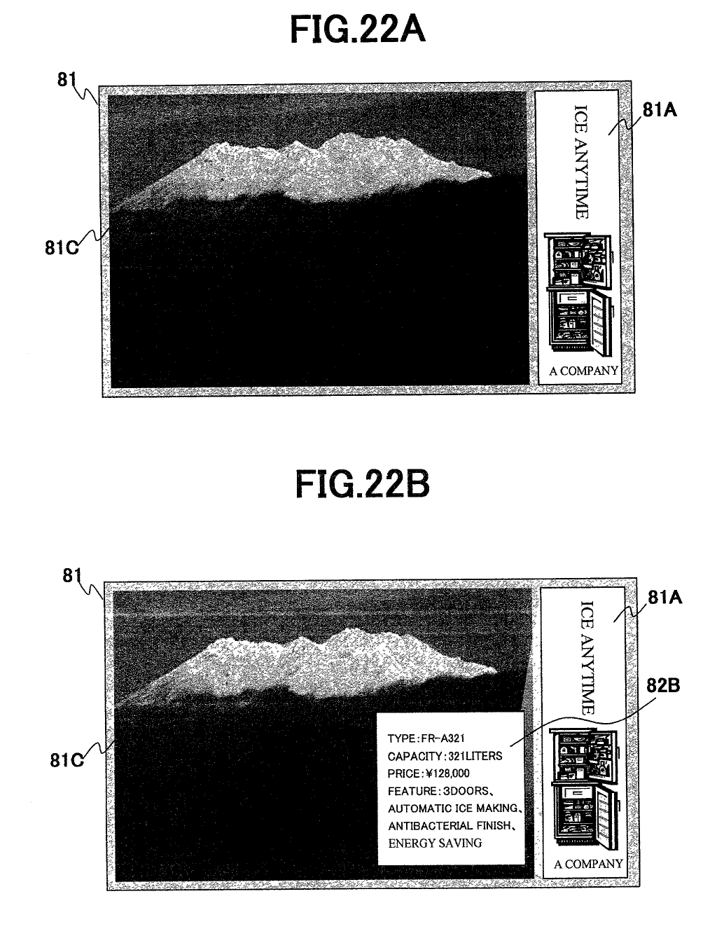

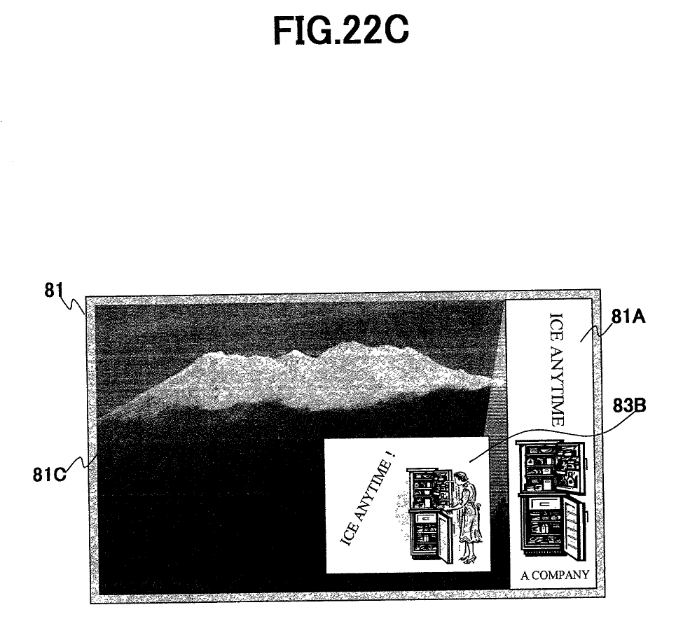

In addition, the display data generation section 16 can show a display related to a commercial on a broadcast program display. FIGS. 22A to 22D are explanatory views showing display examples in this case.

As shown in FIGS. 22A to 22D, a display 81C on which a picture on a broadcast program or the like is deformed or reduced and a banner advertisement display 81A appear on a screen 81. The banner advertisement display 81A is arranged in the right corner of the screen and consists of character data or multimedia data. Picture information on which the banner advertisement display is based is received by the broadcast reception section 11 or the transmission-reception section 13, and recorded and stored in the data storage section 14. In this case, too, the information is recorded and stored based on the commercial program guide and the banner advertisement is displayed based on the stored program guide as in the cases of the respective displays described above. It is noted that the banner advertisement data, the commercial program guide and commercial program related information are managed by the information management section 15.

When the user depresses the “CM detail” button 71B on the remote controller 71 in a state of the screen 81, the display data generation section 16 displays a detailed information window 82B as shown in FIG. 22B, on which window detailed information on the product associated with the banner advertisement is displayed. Moreover, when the user depresses the “CM replay” button 71C on the remote controller 71 in a state in which the detailed information window 82B appears, the display data generation section 16 displays a replay window 83B as shown in FIG. 22C. In this replay display window 83, commercial pictures associated with the banner advertisement are replayed.

If the user depresses the “CM detail” button 71B or the “CM replay” button 71C on the remote controller 71 again after displaying the detailed information window 82B or the replay window 83B, the window 82B or 83B is closed. It is also possible to conduct other operations including an operation for automatically closing the window after a certain time period passes, by presetting these operations. In addition, the detailed information window or the like can be set to be displayed not on the broadcast program display but on the banner advertisement display 81A after being subjected to a processing such as deformation or reduction.

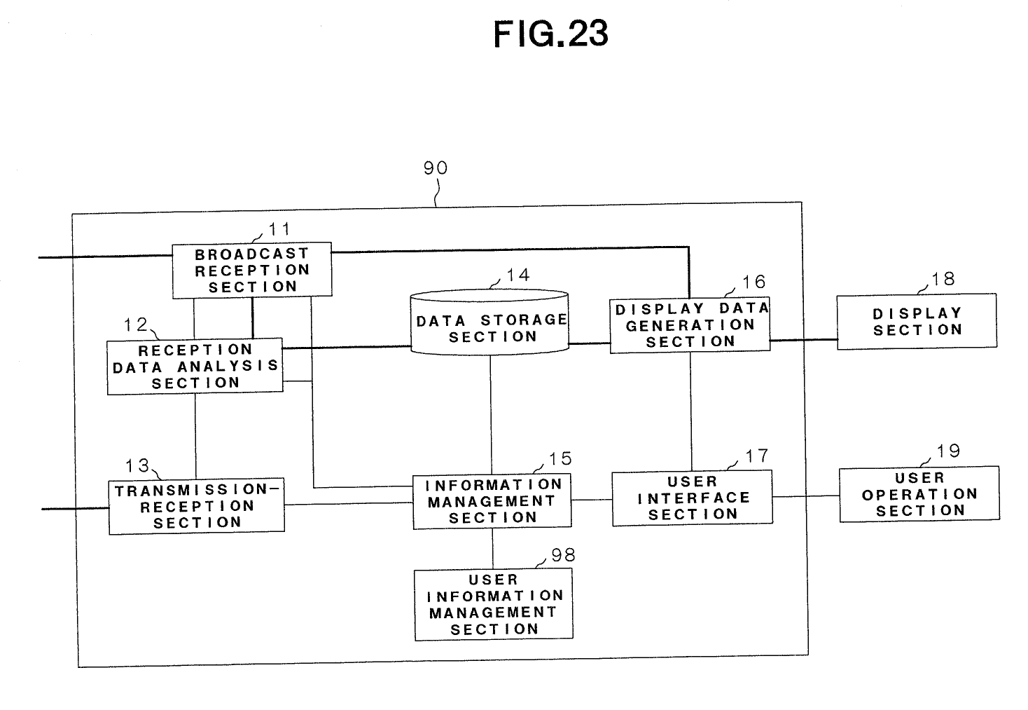

FIG. 23 is a block diagram showing an information storage apparatus according to another embodiment of the present invention. In FIG. 23, the same constituent elements as those in FIG. 11 are denoted by the same reference symbols and will not be described herein.

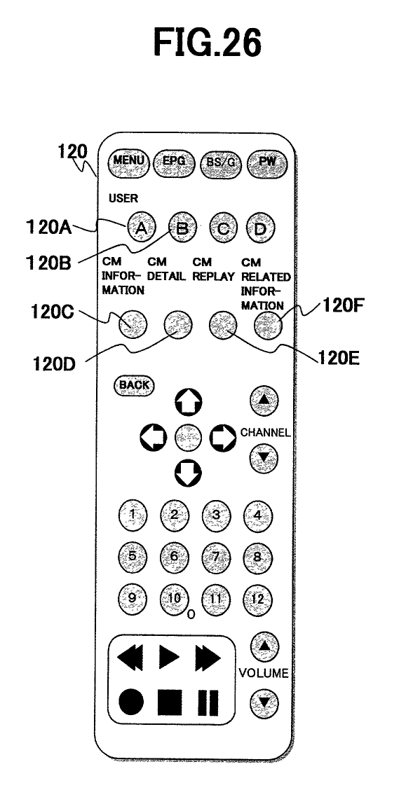

The information storage apparatus 90 in this embodiment differs from the information storage apparatus shown in FIG. 11 in that a user information management section 98 is added. The user information management section 98 stores and manages information based on user's operation for each user. In this case, a remote controller 120 shown in FIG. 26, for example, is used as a user operation section 19.

The remote controller 120 has a plurality of buttons 120A, 120B, . . . to specify a user. A user operates these buttons, thereby making it possible to instruct that the following remote controller operation is carried out by the user designated by the buttons. The user operation section 19 outputs a signal based on the designation of the user and the user's operation to an information management section 15 through a user interface section 17. As a result, the user information management section 98 is controlled by the information management section 15 to manage user specific settings according to the user's operation.

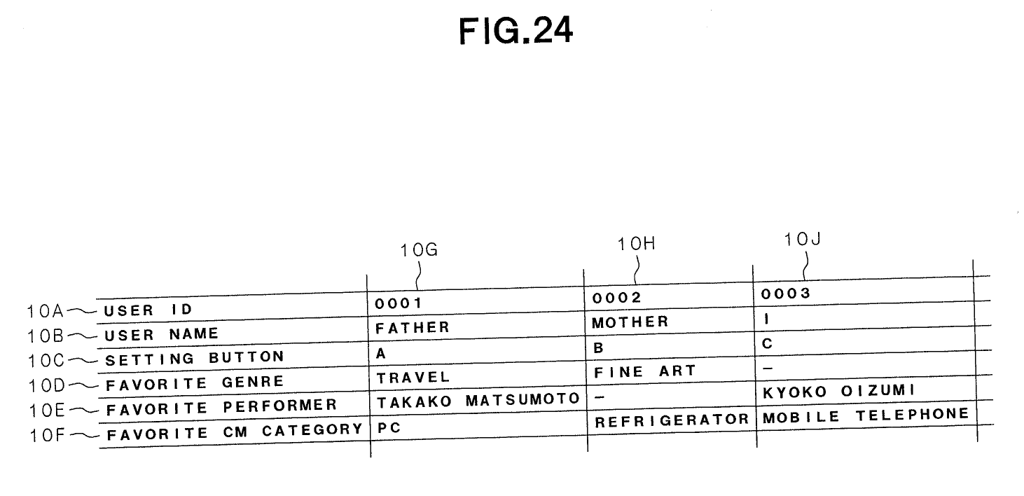

FIG. 24 is an explanatory view showing a personal information management table managed by the user information management section 98.

As shown in FIG. 24, the personal information management table in the information storage apparatus 90 has a user ID item which is a univocal user identifier, e.g., a user name allotted to, for example, each of the user buttons 120A, 120B, . . . on the remote controller 120, a setting button item for specifying the respective user buttons, a favorite genre item, a favorite performer item and a favorite CM category item.

The user operates the user buttons 120A, 120B, . . . on the remote controller 120 or the like and sets the respective items on the personal information management table. Needless to say, items other than those shown in FIG. 24 may be set on the personal information management table.

The personal information management table has regions according to users (columns shown in FIG. 24). For example, a column 10H is a region for a user designated by “mother” as a user name and allotted “0002” as a user ID. It is noted that the user ID is not shown to the user and automatically allotted to the user when setting personal information. The user ID “0002”, (with user name “mother”) is allotted to the user button “B” 120B on the remote controller 129, while a favorite genre is set at “fine art”, a favorite performer is unset, a favorite CM category is set at “refrigerator”.

In the example of FIG. 24, a plurality of items cannot be set to each of items 10A, 10B and 10C. However, a single or a plurality of items can be set to each of items 10D, 10E and 10F or these items may remain blank. In addition, it is not always necessary to set this personal information management table for each user.

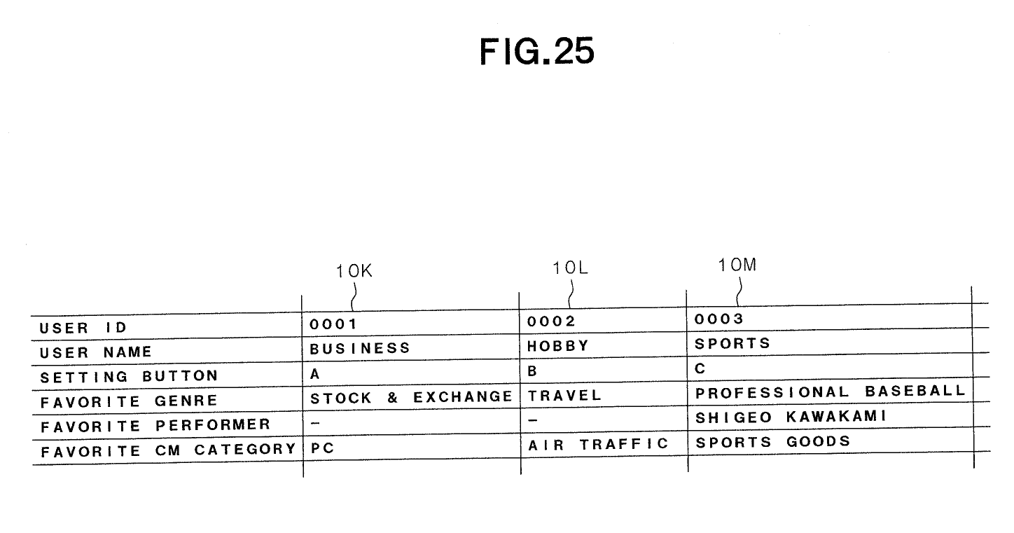

If one user uses the personal information management table, it is possible to manage information according to interesting fields. FIG. 25 is an explanatory view showing a personal information management table in this case and showing that one user make a setting for each interesting field. In FIG. 25, business related information, hobby related information and sports related information are set in columns 10K, 10L and 10M, respectively.

In this embodiment, the personal information management table is used when a broadcast program or a commercial is recorded and replayed (viewed and listened to).

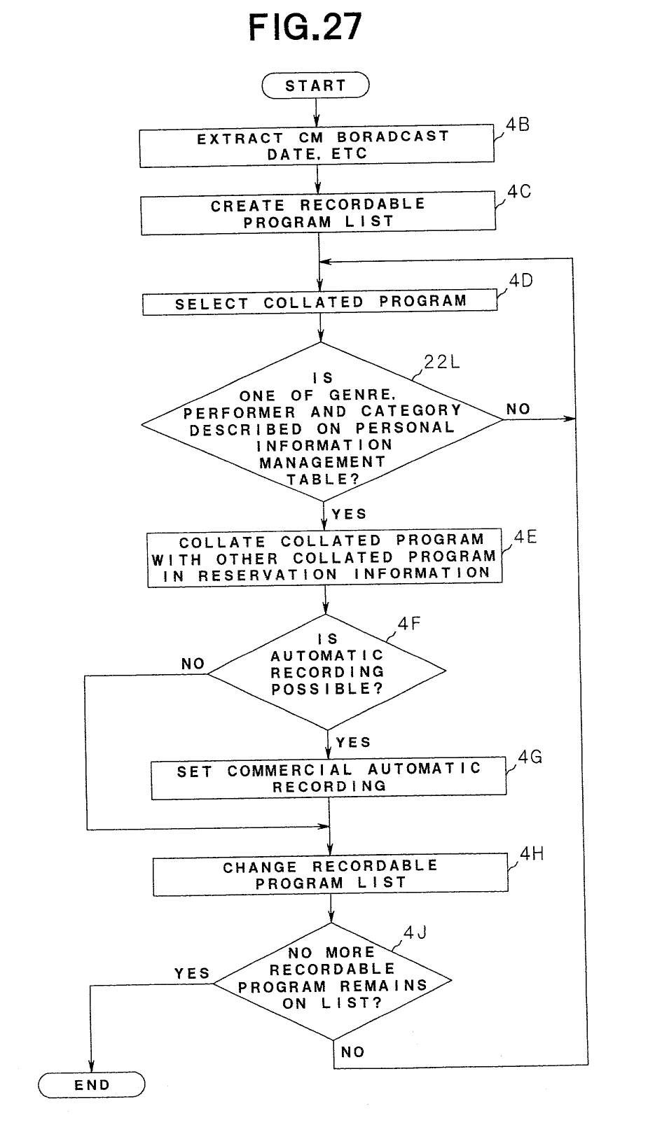

Next, the operation of this embodiment constituted as stated above will be described with reference to a flow chart shown in FIG. 27. In FIG. 27, the same procedures as those in FIG. 12 are denoted by the same reference symbols and will not be described herein.

In this embodiment, commercial and commercial program guide processings are the same as those in FIG. 11. Various commercial automatic recording setting algorithms may be available. For example, a commercial is automatically recorded using an algorithm shown in FIG. 27.

That is to say, operation steps until creating a recordable program list in accordance with stored program guides and selecting a collated program are the same as those in the embodiment shown in FIG. 11.

In this embodiment, in the next step 22L, it is examined whether or not one of the genre, performer and category of the stored program guide is described on the personal information management table. If not described, the program is not recorded and the processing is returned to the selection of the next recordable program (in a step 4D). If described, information on the program is collated with information, such as the recording time, channels or the like of another recordable program, necessary for recording reservation (in a step 4E).

The remaining functions are the same as those shown in FIG. 12.

In this embodiment, personal information set on the personal information management table can be utilized when the user views and listens to the commercial. It is now assumed that the personal information management table shown in FIG. 24 is managed by the user information management section 98 and that the user depresses the user button allotted to the user so as to set the present user at the time of starting the device or at other arbitrary timing. It is assumed, for example, that the present user is “mother”. The user depresses the user button 120B so as to set the user name at “mother”. This user operation is transmitted from the user interface section 17 to the information management section 15. The information management section 15 collates information on the present user with the information stored in the user information management section 98 and sets that the present user is a user with the user ID “0002”.

Next, it is assumed that the user depresses a “CM information” button 120C on the remote controller 120 shown in FIG. 26. An instruction based on this operation is received by the user interface section 17 and information indicating that the instruction to display commercial information is issued from the user is transmitted to the information management section 15. The information management section 15 shows a commercial display in response to the instruction from the user.

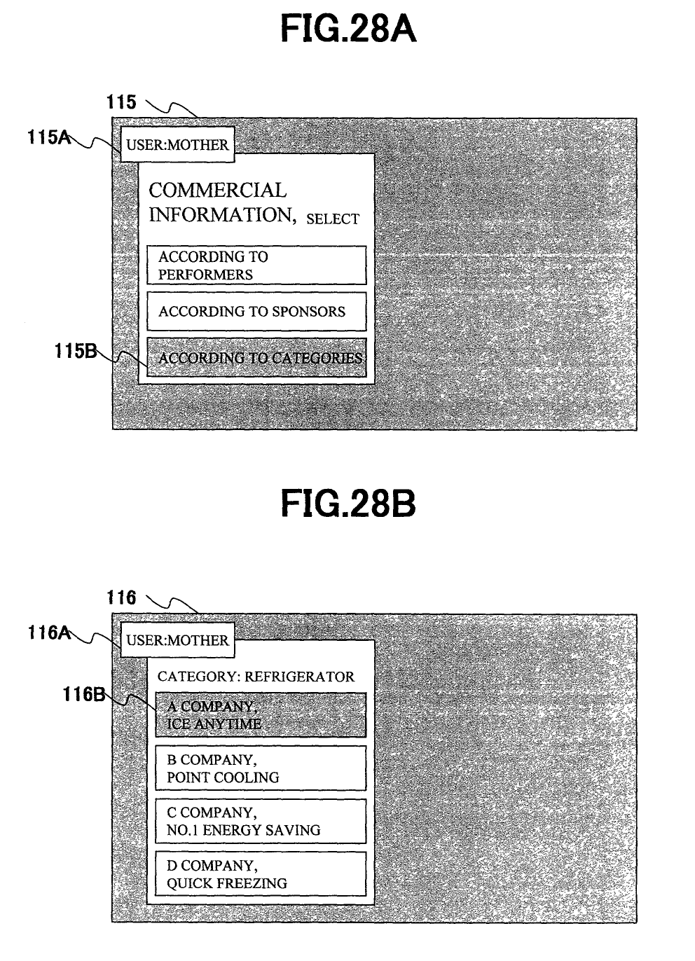

FIGS. 28A and 28B are explanatory views showing a commercial display 115 in this case.

As similar to the embodiment in FIG. 11 the user conducts a selection operation as to how to view and listen to the commercial information so as to search, view and listen to the commercial information. For example, the user operates cursor keys or the like on the remote controller 120 and selects an option 115B. Namely, it is assumed that the user selects a display according to categories.

If so, the user interface section 17 outputs information indicating that a display according to categories is selected, to the information management section 15. The information management section 15 transmits and receives data to and from the user information management section 98, determines that the content of the “favorite CM category” item on the use ID “0002” column on the personal information management table is “Refrigerator” and outputs this information to a display data generation section 16 through the user interface section 17. The display data generation section 16 thereby lists commercials in Class 2 category “Refrigerator” of the stored program guides (see FIG. 15), fetches the sponsors and CM titles of these commercials, arranges the character strings thereof and displays a category display 116 shown in FIG. 28B on a screen.

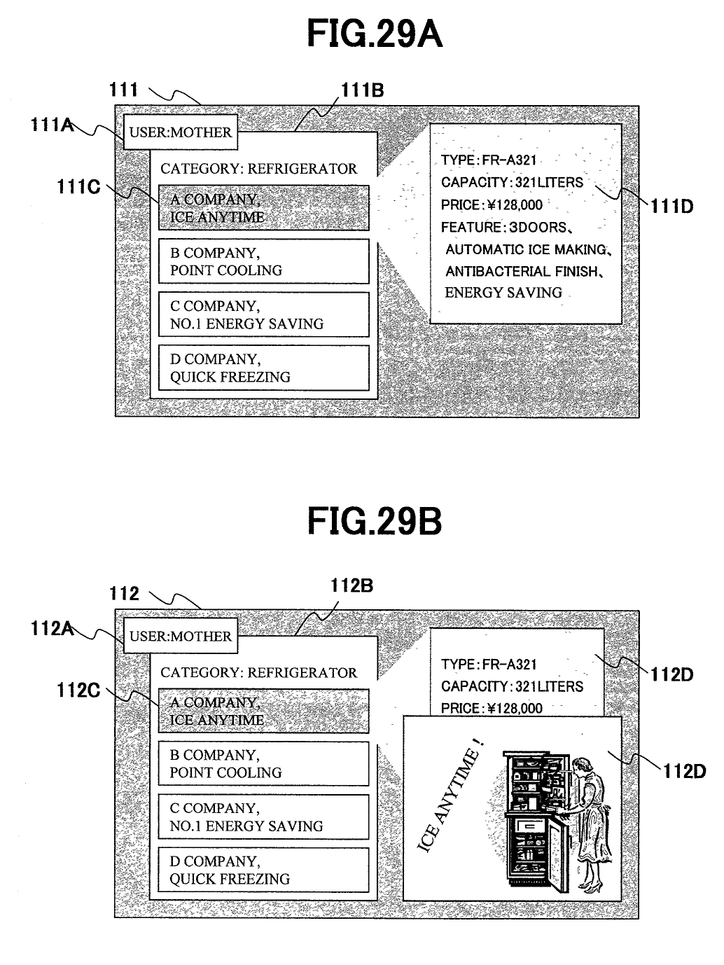

Further, it is assumed that the user depresses a “CM detail” button 120D on the remote controller 120 while an option 116B “Ice Anytime” is selected. If so, the display data generation section 16 displays character strings described in a detailed information part of the corresponding program guide and thereby shows a detailed information display 111 shown in FIG. 29D on the screen. On the detailed information display 111, a window 111D indicating detailed information appears.

If the user depresses the “CM detail” button 120D on the remote controller 120 again, the window 111D is closed. It is also possible to conduct other operations including an operation for automatically closing the window after a certain time period passes by presetting these operations.

Next, it is assumed that the user depresses a “CM replay” button 120E on the remote controller 120 while the detailed information display 111 appears on the screen. If so, a commercial picture display 112 shown in FIG. 29B appears. On the commercial picture display 112, a window 112D projecting commercial pictures appears.

A method of showing the commercial picture display 112 is the same as that in the embodiment in FIG. 11.

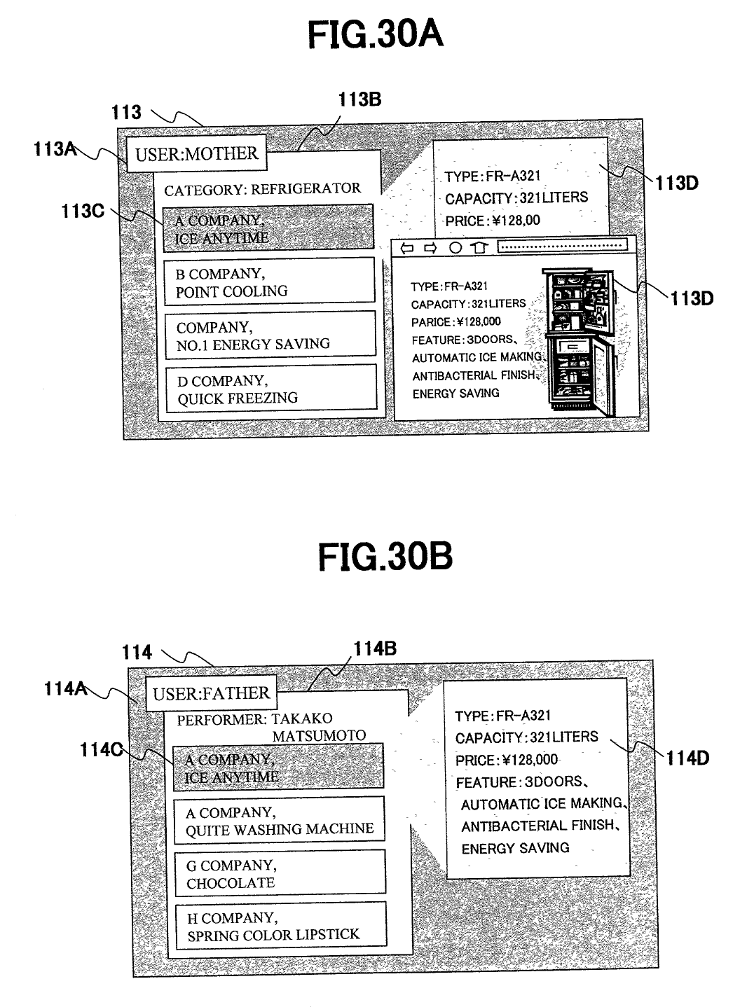

Furthermore, if the user depresses a “CM related information” button 120F on the remote controller 120 while the detailed information display 111 appears on the screen, a related information display 113 shown in FIG. 30A appears. On the display 113, a window 113D displaying commercial related information appears.

A method for showing the related information display 113 or the like is the same as that in the embodiment shown in FIG. 11, as well.

If the user plans to purchase a product or the like, it is possible to store a plurality of product information, commercial pictures, related information and the like on this product by user's setting items related to the product which the user plans to purchase in the favorite category item of personal information. Viewing and listening to these pieces of information and data by a method shown in FIGS. 29A and 29B helps the user conduct a product comparison and study.

Further, FIG. 30B shows a detailed information display 114 if user “father” selects “according to performers” for displaying commercials. Conventionally, it is difficult to know the broadcast time and contents of commercials in advance. If the user intends to view and listen to commercials on which a user's favorite actor, actress or performer appears or hot commercials, there is no other choice but to record television programs for a long time to thereby increase the possibility that the favorite performer appears. In this embodiment, by contrast, by setting the performer or the like in the favorite item, it is possible to automatically store, view and listen to commercials on which a favorite performer appears or hot commercials.

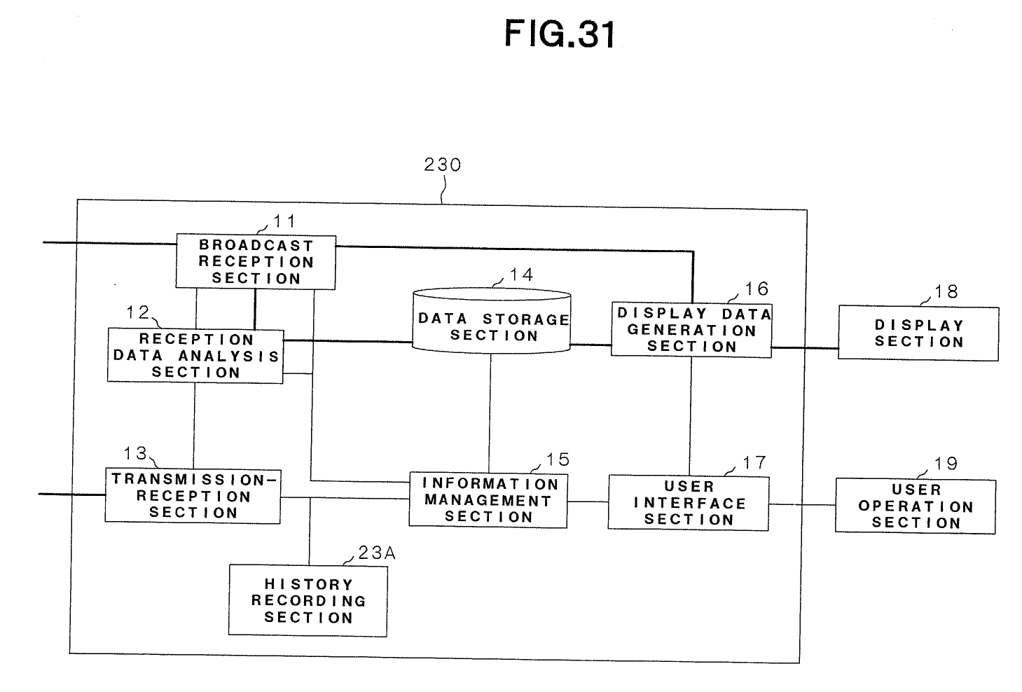

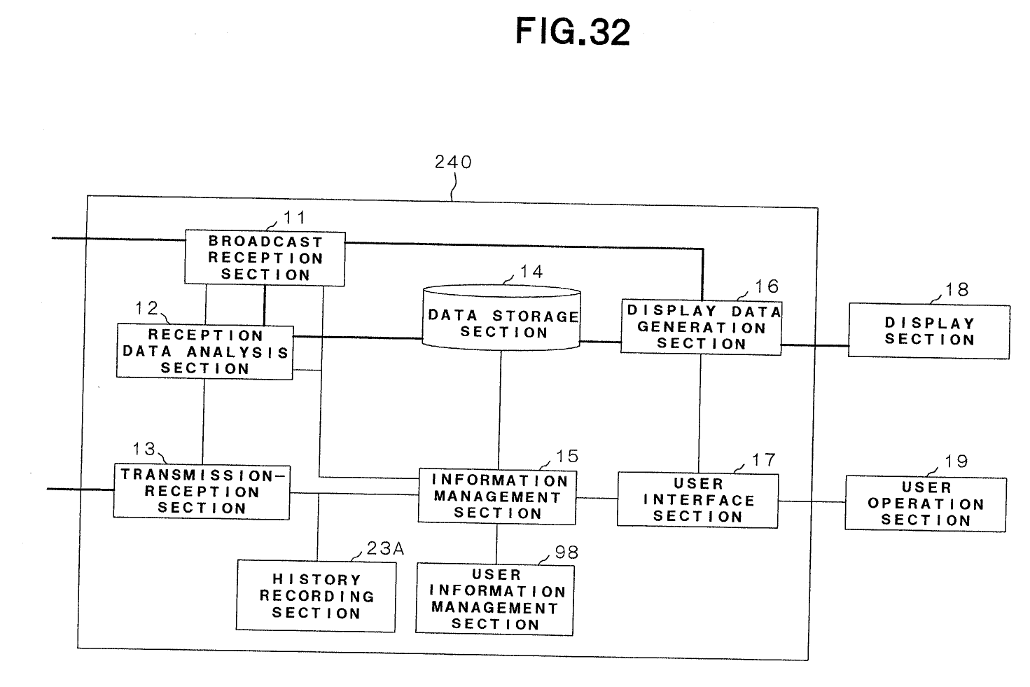

FIGS. 31 and 32 are block diagrams showing an information storage apparatus according to yet another embodiment of the present invention. In FIGS. 31 and 32, the same constituent elements as those in FIG. 23 are denoted by the same reference symbols and will not be described herein. In this embodiment, the history of commercials which a viewer recorded or replayed is returned to a service information provider to allow the history to be used for marketing or the like.

The embodiment shown in FIGS. 31 and 32 differs from the embodiment shown in FIGS. 11 or 23 in that a history recording section 23A is added to the information storage apparatus.

In the embodiment shown in FIG. 11, the user who is the service recipient 21 selects an interesting commercial and views and listen to the commercial. In the embodiment shown in FIG. 23, the user selects an interesting commercial even while the commercial is being recorded and stored. In this embodiment, history data on user's selection of commercials is returned to a service information provider 24, thereby enabling a sponsor 23, a service sender 22 or the service information provider 24 to make use of the history data.

The history recording section 23A records a commercial recorded on the data storage section 14 or a commercial replayed from the data storage section 14. For example, the history recording section 23A may sequentially record the CM ID's of the commercials recorded or replayed as history data. The history recording section 23A shown in FIG. 32 may record, as more detailed data, data such as the genres, performers and categories on the personal information management table managed by the user information management section 98 together with the CM ID's.

The history data acquired by the history recording section 23A is recorded and held by recording unit which is not shown, transmitted from a transmission-reception section 13 to the service information provider 24 through communication network 6 at real time at predetermined timing or at a time when information has been collected.

The history data is utilized by the service information provider 24, the sponsor 23 or the service sender 22 based on the contract concluded between the service recipient and the service information provider 24 with or without consideration.

The personal information stored in the information storage apparatuses 31 and 32 is provided based on the contract concluded between the service recipient 21 and the service information provider 24 with or without consideration or based on the contract between the parties concerned constituting the system. In addition, the history data return mechanism can be adapted to information or data other than commercial related information or data.

For example, broadcast program viewing histories and the like recorded on the information storage apparatuses 31 and 32 can be provided through the service information provider 24 to the respective parties concerned. By doing so, the sponsor 23 providing the commercial product or the like can get grasp of the consumption trend of viewers (consumers) and utilize the grasped consumption trend for the production of products and the like. In addition, the service sender 22 producing and providing broadcast programs or the like can get grasp of the consumption trend of viewers and utilize the grasped consumption trend for the production of programs and the like.

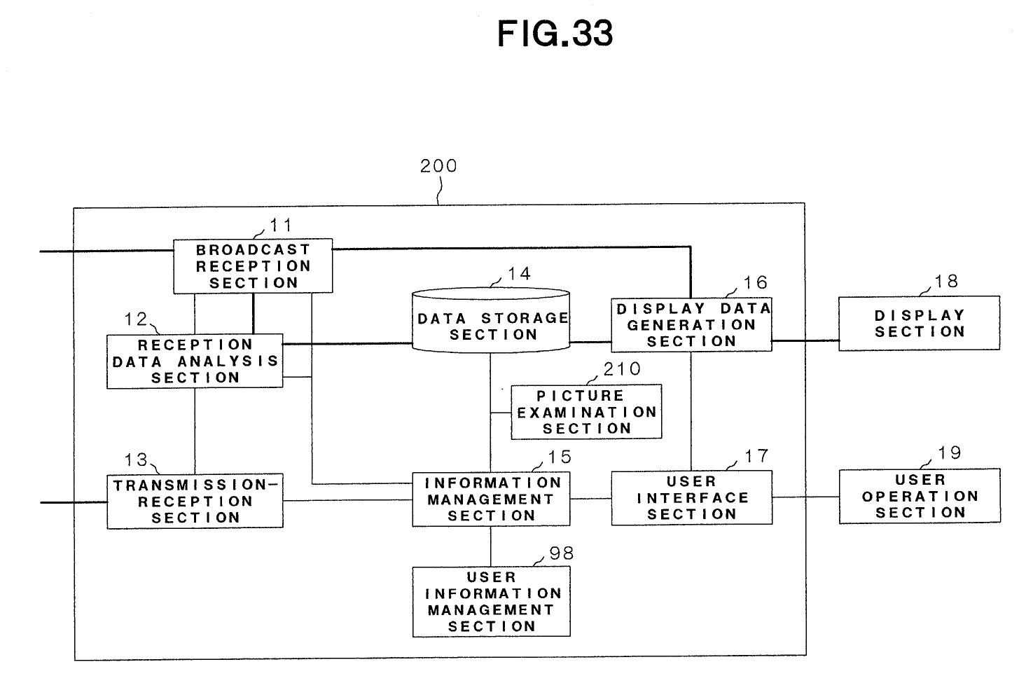

FIG. 33 is a block diagram showing the constitution of an information storage apparatus in yet another embodiment of the present invention. In FIG. 33, the same constituent elements as those in FIG. 23 are denoted by the same reference symbols and will not be described herein.

An information storage apparatus 200 in this embodiment differs from the information storage apparatus 90 shown in FIG. 23 in that a picture examination section 210 is added to the apparatus. The picture examination section 210 detects whether or not a superimposed picture exists or determines whether or not a reception state is good, and examines whether or not a noise picture exists in commercial pictures.

The noise picture unit, for example, a picture on which data or information unrelated to picture and voice data such as a commercial is displayed in a part of the picture or a picture having picture quality lower than a predetermined standard set separately if a reception state is bad due to the influence of whether or the like. The examination of a noise picture may be conducted by a picture processing method or the like. The method should not be, however, limited to any specific method.

The examination result of the picture examination section 210 is supplied to an information management section 15. If a superimposed picture exists in commercial pictures or a reception state is bad, the information management section 15 records and stores a newly received commercial in the data storage section 14.

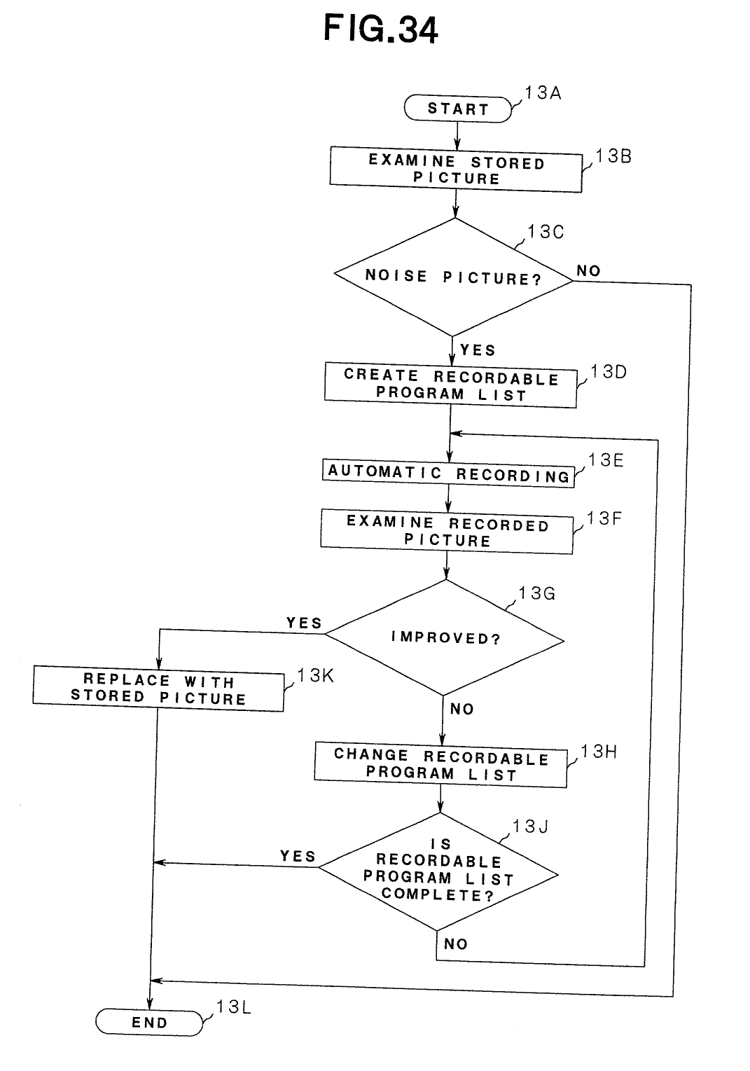

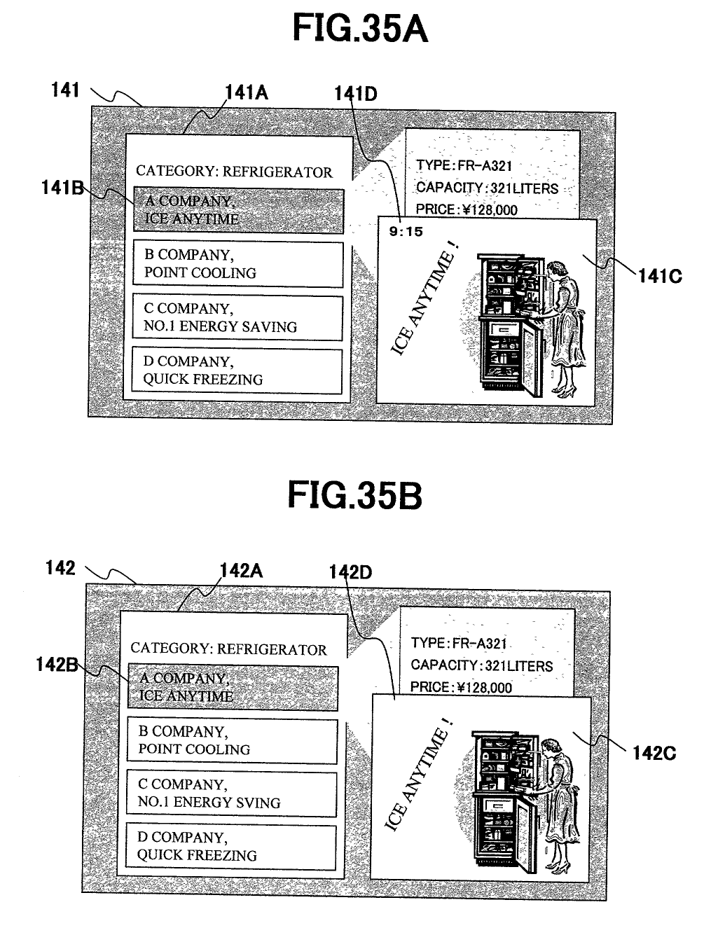

Next, the operation of this embodiment constituted as stated above will be described with reference to a flow chart shown in FIG. 34 and explanatory views shown in FIGS. 35A and 35B.

The operation of this embodiment is the same as that of the embodiment shown in FIG. 23 in that commercials and a commercial program guide are transmitted through a communication network 6 (see FIG. 1) or a broadcast network 3, the commercials and the program guides are stored based on the commercial program guide, and the like. Also, the operation of this embodiment is the same as that of the embodiment shown in FIG. 23 in that a commercial is replayed based on the program guide.

FIGS. 35A and 35B show commercial picture displays 141 and 142 for a commercial with a commercial title of “Ice Anytime”. On the commercial picture display 141, a window 141C projecting commercial pictures appears.

Further, a time display 141D appears on the upper left portion of the window 141C projecting the commercial pictures. Such information or data unrelated to the commercial is sometimes superimposed on the commercial pictures and broadcast. In this case, these pieces of information may be possibly recorded simultaneously with the automatic recording of the commercial.

These pieces of information or data (noise picture) which are not directly related to the commercial obstruct the view for users. In case of the display of time or the like, the user may mistake the displayed time for present time and be confused. Further, it is disadvantageous to the sponsor, as well, since part of the information which the sponsor wishes to deliver by the commercial misses. In this way, the noise picture is often to the disadvantage of both the commercial sender and recipient.

Considering this, in this embodiment, the picture examination section 210 examines whether or not a noise picture is included in commercial pictures recorded and stored in the data storage section 14 at predetermined timing (in a step 13B). The picture examination section 210 selects one of the stored pictures and examines whether the selected picture is a noise picture. If the picture examination section 210 does judge that the noise picture is included in the commercial pictures, processings after a step 13C are not carried out and processings for the selected stored picture is not carried out (in a step 13L).

If judging that a noise picture is included in pictures which are being examined, the picture examination section 210 creates a possible recording time list for the examined commercial based on the broadcast information described in the program guide (in a step 13D). In case of creating a list, the priority of the corresponding time zone is decreased so as to prevent the same noise picture from being recorded in the zone.

Using the created possible recording time list, the commercial pictures are automatically recorded according to the same algorithm as those in the respective embodiments stated above. In this case, the recorded pictures are stored in a temporary state in which a temporary storage area or a temporary file identifier is added. If automatic recording is conducted, the picture examination section 210 examine whether or not a noise picture exists. When automatic recording starts, it is examined whether a noise picture exists (in a step 13F). If the degree of the noise is improved from the pictures stored in advance (in a step 13G), the pictures stored in a temporary state are stored again as originally stored pictures (in a step 13K).

As a result of the examination of the newly automatically recorded commercial pictures, if the degree of noise is not improved from the pictures stored in advance, the possible automatic recording time is changed in a step 13H and the same processing is repeated until no alternative exists (in a step 13J).

FIG. 35B shows a commercial picture display 142 displaying a commercial with commercial title “Ice Anytime” after pictures are replaced according to the algorithm shown in FIG. 34. In a window 142D on the display 142, a time display 142D appears.

As can be seen, in this embodiment, it is possible to display commercial pictures which the user can easily view without noise pictures.

Furthermore, in this embodiment, the existence of the noise picture is examined, thereby recording and storing commercial pictures in other recording time zones of the same commercial. It is also possible to record and store a different version of the commercial for other reasons.

Normally, a plurality of versions of commercial pictures having different time zones exist. Since the sponsor 23 (see FIG. 1) wishes to provide more information to the service recipients 21 who are consumers, longer commercial pictures are desirably recorded and stored if the commercial is the same in version. If the number of the commercial pictures which can be associated with the program guide recorded and stored is limited to one, a commercial picture more suitable for the desire of the sponsor 23 can be recorded and stored by making commercial time comparison without examining the existence of a noise picture. Namely, if the sponsor wishes to provide commercial pictures in a version as long as possible, 30-second commercial pictures are recorded after 15-second commercial pictures are stored, thereby replacing the 15-second commercial pictures with the 30-second commercial pictures.

Moreover, if the recording capacity for recording and storing entire commercial pictures in the data storage section 14 is limited despite the user's desire to store many types of commercials, then commercial pictures more suitable for the user's desire can be recorded and stored by making time comparison without examining the existence of a noise picture. That is to say, in this case, if 15-second commercial pictures are recorded after 30-second commercial pictures are stored for the same commercial, then the 15-second commercial pictures are replaced with the 30-second commercial pictures.

It is evident that different embodiments can be constituted in a wide range based on the present invention without departing from the spirit and scope of the invention. The present invention should not be limited by specific embodiments while the invention is limited by claims which follow.

What is claimed is:

1. An information delivery system comprising:
information delivery unit configured to delivery predetermined information, and for creating a delivery schedule for delivering said predetermined information;
information providing unit configured to create a delivery information guide based on said delivery schedule provided by said information delivery unit, said delivery information guide created by making at least one of a determination of a change in a content of said delivery schedule and a determination of a content of additional information added to said delivery schedule in accordance with at least one of a consideration for delivering the predetermined information by said information delivery unit and a consideration for creating said delivery information guide; and
information storage unit configured to receive the delivery information guide from said information providing unit, and for receiving and storing the predetermined information from said information delivery unit based on the received delivery information guide.

2. An information delivery system according to claim 1, wherein
said information storage unit and said information delivery unit mutually transmit signals through a predetermined electric communication line; and said information delivery unit transmits said delivery schedule to sad information providing unit through a predetermined electric communication line.

3. An information delivery system according to claim 1, wherein
said information providing unit uses, as said additional information, priority information in accordance with at least one of the consideration for delivering the predetermined information by said information delivery unit and the consideration for creating said delivery information guide.

4. An information delivery system according to claim 3, wherein
said information storage unit determines a storage priority of the predetermined information from said information delivery unit based on said priority information.

5. An information delivery system according to claim 1, further comprising:
information presenting unit configured to store an information guide based on said delivery information guide received by said information storage unit, for reading said predetermined information stored in said information storage unit based on said information guide thus stored, and for presenting said predetermined information thus read based on said predetermined information.

6. An information delivery system according to claim 5, further comprising:
history information transmission unit configured to transmit information based on a history of presenting information by said information presenting unit, to said information providing unit.

7. An information providing apparatus comprising:
reception unit configured to receive and store a delivery schedule for delivering predetermined information;
delivery information guide creation unit configured to create a delivery information guide based on said delivery schedule, said delivery information guide created by making at least one of a determination of a change in a content of said delivery schedule and a determination of a content of additional information added to said delivery schedule in accordance with at least one of a consideration for delivering said predetermined information and a consideration for creating said delivery information guide; and
delivery information guide transmission unit configured to transmit said delivery information guide.

8. An information providing apparatus according to claim 7, wherein
said delivery information guide creation unit creates said delivery information guide in accordance with the consideration after adding information according to a content of said predetermined information to said delivery schedule received by said reception unit.

9. An information delivery system according to claim 7, wherein
said delivery information guide creation unit uses, as said additional information, priority information in accordance with at least one of the consideration for delivering said predetermined information and the consideration for creating said delivery information guide.

10. An information providing apparatus according to claim 8, wherein
said delivery information guide creation unit determines addition of information according to the content of said predetermined information, in accordance with at least one of the consideration for delivering said predetermined information and the consideration for creating said delivery information guide.

11. An information storage apparatus comprising:
delivery information guide reception unit configured to receive a delivery information guide based on a delivery schedule for delivering predetermined information, the delivery information guide created by making at least one of a determination of a change in a content of said delivery schedule and a determination of a content of additional information added to said delivery schedule in accordance with at least one of a consideration for delivering said predetermined information and a consideration for creating said delivery information guide;
information management unit configured to determine whether to store said predetermined information thus delivered based on said delivery information guide; and
delivery information storage unit configured to record and store said predetermined information delivered according to a determination of said information management unit.

12. An information storage apparatus according to claim 11, further comprising:
information guide storage unit configured to store an information guide based on said delivery information guide received by said delivery information guide reception unit; and
presentation information generation unit for reading said predetermined information stored in said delivery information storage unit based on said information guide stored in said information guide storage unit, and for making a presentation based on said predetermined information thus read.

13. An information storage apparatus according to claim 11, wherein
said information management unit determines whether to store said delivered predetermined information based on priority information, the priority information being the additional information included in said delivery information guide.

14. An information storage apparatus according to claim 11, wherein
said presentation information generation unit hierarchically displays the content of said information guide and said delivered predetermined information for each classification, in accordance with classifications included in said information guide.

15. An information storage apparatus according to claim 14, further comprising:
user interface unit configured to allow change hierarchical display by said presentation information generation unit in response to a user's operation to move a hierarchy on said hierarchical display.

16. An information storage apparatus according to claim 15, further comprising:
history information storage unit configured to store information based on an history of the user's operation by said user interface unit; and
history information transmission unit configured to transmit said history information.

17. An information storage apparatus according to claim 11, wherein:
said delivery information storage unit comprises:
noise information detection unit configured to detect noise information included in said predetermined information stored; and
update unit configured to detect that same information as said predetermined information including said noise information is delivered again from said delivery information guide, and for recording and storing the information again.

18. An information providing method comprising:
a processing for delivering predetermined information, and for creating a delivery schedule for delivering said predetermined information;
a processing for creating a delivery information guide based on said delivery schedule by making at least one of a determination of a change in a content of said delivery schedule and a determination of a content of additional information added to said delivery schedule in accordance with at least one of a consideration for delivering said predetermined information and a consideration for creating said delivery information guide.

19. An information providing method according to claim 18, further comprising:
a processing for receiving said delivery information guide, and for receiving and storing said predetermined information based on the received delivery information guide.

20. An information providing method comprising:
a processing, conducted at a broadcasting station, for creating a broadcast schedule for broadcasting advertisement information;
a processing, conducted in an information providing apparatus, for creating a commercial program guide based on said broadcast schedule by making a change and an addition to said broadcast schedule in accordance with at least one of advertisement rates for broadcasting said advertisement information and a profit for creating said commercial program guide; and
a processing, conducted in an information storage device, for receiving said commercial program guide transmitted from said information providing apparatus through a predetermined communication network, and for recording and storing the advertisement information from said broadcasting station based on said commercial program guide thus received.
